(19) United States
(12) Patent Application Publication
(10) Pub. No.: US 2019/0268777 A1
(43) Pub. Date: Aug. 29, 2019

(54) NEXT GENERATION MULTI-CHANNEL-TENANT VIRTUALIZED BROADCAST PLATFORM AND 5G CONVERGENCE

(71) Applicant: Sinclair Broadcast Group, Inc., Hunt Valley, MD (US)

(72) Inventors: Michael J. SIMON, Frederick, MD (US); Mark A. AITKEN, Parkton, MD (US); Ebenezer K. KOFI, Hunt Valley, MD (US)

(73) Assignee: Sinclair Broadcast Group, Inc., Hunt Valley, MD (US)

(21) Appl. No.: 16/286,119

(22) Filed: Feb. 26, 2019

Related U.S. Application Data
(60) Provisional application No. 62/635,283, filed on Feb. 26, 2018.

(51) Int. Cl. H04W 16/14; H04W 16/10; H04W 72/00; H04W 28/24; H04L 12/715

(52) U.S. Cl. CPC H04W 16/14; H04W 16/10; H04L 45/64; H04W 28/24; H04W 72/005

(57) ABSTRACT

Wireless system architectures worldwide are undergoing a paradigm shift today. This, by adopting new technology and wireless system architectures based on Software Defined Network (SDN) and Network Function Virtualization (NFV) that are being instantiated using IT cloud computing methods. The 3 GPP is defining a new 5G radio and 5G core network in release 16 based on a cloud native system architecture. Herein, a new next generation multi-channel-tenant virtualized broadcast platform using SDN/NFV is disclosed using ATSC 3.0 standards A/321, A/322 as a baseline.

### CROSS-REFERENCE TO RELATED APPLICATIONS

The present application claims the benefit of U.S. Provisional Patent Appl. No. 62/635,283, filed Feb. 26, 2018, which is incorporated herein by reference in its entirety. This application is related to U.S. patent application Ser. No. 14/092,993, filed Nov. 28, 2013, now U.S. Pat. No. 9,843,845, which is incorporated herein by reference in its entirety.

### BACKGROUND

U.S. patent application Ser. No. 14/092,993 was filed in 2013 before emergence and use of Software-Defined Networking (SDN) and Network Functions Virtualization (NFV) in wireless architectures. Furthermore, the broadcast market exchange (BMX) orchestration entity disclosed therein is now evolved in era of wireless IT cloud computing system architectures.

In the United States, a new terrestrial broadcast broadband standard Advanced Television Systems Committee (ATSC) 3.0 has been developed and ATSC 3.0 A/321, A/322 standards were adopted into the FCC rules in November 2017, the broadband standard ATSC 3.0 is incorporated herein by reference in its entirety. The FCC has permitted broadcasters to voluntarily use ATSC 3.0 on a free market driven basis to enable innovation.

However, Federal Communications Commission (FCC) rules require the current ATSC 1.0 standard to continue to be broadcasted. Since ATSC 1.0 and new ATSC 3.0 are technically incompatible for simultaneous transmission in the same 6 MHz channel, the FCC has permitted broadcasters interested in ATSC 3.0 to voluntarily form virtual broadcast spectrum pools and channel sharing agreements among themselves. Some broadcast spectrum pools and shared channels can be used to broadcast ATSC 1.0 as required. Other shared channels are used to voluntarily explore ATSC 3.0 on a free market driven basis. This is voluntary as each licensed broadcaster can choose to continue broadcasting ATSC 1.0 and not explore ATSC 3.0 or voluntarily enter into virtual channel sharing agreements to explore ATSC 3.0.

Therefore, in the United States to explore ATSC 3.0 on a voluntary basis, interested licensed broadcasters require new technology and system architecture to enable efficient virtual broadcast spectrum pools and sharing of channels permitted by the FCC.

Broadcasters can play an important role in defining new broadcast-like use cases for their spectrum driven by a free-market. The real value of broadcast spectrum can only be unlocked by serving mobile devices (e.g. Automotive, IoT, Handheld, Wearable, etc.).

It is therefore believed that broadcasting must be mobilized to continue to remain relevant serving their local communities with media, entertainment, news, emergency warnings and alerts. This will then define the best use of their licensed broadcast spectrum in the interest of a mobile society.

### SUMMARY OF THE DISCLOSURE

The technology, system architecture, and methodology used to form efficient broadcast spectrum resource pools and channel sharing for ATSC 3.0 broadcasters is disclosed herein. This allows broadcasters to monetize their spectrum and create new broadcast business models in a free market.

The concept of virtual channel sharing has been used in the wireless industry for years and is well accepted by mobile virtual network operators (MVNO). Virtual channel sharing will be even more important for 5G as new vertical industries are created.

The ATSC 3.0 standard incorporates latest most spectral efficient physical layer orthogonal frequency-division multiplexing OFDM technology and is based on Internal Protocol (IP) layer transport. The technology, system architecture, and methodology disclosed herein enable efficient broadcast channel sharing on a fair and open basis which is verifiable for integrity and trust of broadcast users to establish new independent business models.

Two new broadcast physical layer entities the spectrum resource manager (SRM) and cognitive spectrum management (CSM) are introduced. These broadcast physical layer entities are responsible for the creation and management of virtual spectrum resource pools for all channels. Moreover, establishing the metrics for validation of fair open sharing of broadcast channels that can be the foundation of new business models under BMX orchestration are disclosed herein.

The BMX orchestration entity allows the broadcast spectrum resources in the spectrum pool to be treated as a commodity on a free market exchange. Some broadcaster spectrum resources may be programmatically sold to other entities to deliver innovative services via the platform. This is termed broadcast as a backend as a service (BaaS).

Furthermore, the BaaS usage rights are determined in contracts or service level agreements (SLAs) signed by entities in advance. The SLAs are executed using the policy and charging capability of the technology, system architecture, and methodology disclosed herein for new business models based on a 24-hour clock. The spectrum resources are either scheduled in advance or dynamically sold as spectrum resource capacity becomes available by the increased efficient use of spectrum under the BMX orchestration.

The technology, system architecture, and methodology to be disclosed herein represent a form of channel sharing allowed by FCC on a voluntary basis under channel sharing agreements in the United States. Additionally, the emergence of a broadcast software-defined radio (SDR) demodulator chip into market is disclosed and innovation for broadcast 5G convergence 3GPP release 16.

The technology, system architecture, and methodology to be disclosed herein allows the traditional standalone broadcast islands to be abandoned by broadcasters that want to use ATSC 3.0 efficiently on a voluntary market driven basis. It is expected, in the United States, the opportunity enabled by FCC rules for ATSC 3.0 is to shift from the broadcast industry a mandated regulated broadcast industry to voluntary free market innovation business. This change is philosophy for the broadcast industry for can be the most challenging adjustment for broadcasters not the new technology platform.

### BRIEF DESCRIPTION OF THE DRAWINGS/FIGURES

In the accompanying drawings, structures are illustrated that, together with the detailed description provided below, describe exemplary embodiments of the claimed invention. Like elements are identified with the same reference numerals. Elements shown as a single component may be replaced with multiple components, and elements shown as multiple components may be replaced with a single component. The drawings are not to scale, and the proportion of certain elements may be exaggerated for illustration.

FIG. 1 illustrates one example of new intelligent system architecture enabling broadcast spectrum pooling and sharing of channels, broadband, and 5G convergence;

FIG. 2 illustrates one example of intelligent system architecture and the timing of IP content flows for broadcast and 5G convergence;

FIG. 3 illustrates the BMX entity and system architecture before wireless SDN/NFV and cloud computing architectures emerged as described in U.S. patent application Ser. No. 14/092,993;

FIG. 4 illustrates timeline of evolution IT computing and networking from bare metal to virtualization (VM, container) to cloud native computing;

FIG. 5 illustrates the high-level end to end architecture of the entities and the establishment of broadcast spectrum resource pools and channel sharing;

FIG. 6 illustrates broadcaster channel assignment as function of spectrum physics and use case for best resource efficiency BMX orchestration;

FIG. 7 illustrates a context aware network using BMX orchestration driven by policy reflecting will of broadcaster under SLA;

FIG. 8 illustrates BMX orchestration is 86,400 sec/day and is use or lose proposition for a broadcaster's spectrum resources each second;

FIG. 9 illustrates the high-level view of eastbound interface from BMX orchestration entity to manage CDN or Data Lake and ATSC 3.0 home gateway via ISP;

FIG. 10 illustrates the high-level view and concepts of layer 3 broadcast 5G convergence;

FIG. 11 illustrates the high-level view of broadcast market exchange orchestration design framework using virtual network functions;

FIG. 12 illustrates the high-level view of broadcast platform design framework using software defined networking (SDN) and network function virtualization (NFV);

FIG. 13 illustrates concept of broadcast network slicing using the virtualized multi-channel-tenant broadcast sharing platform and SDN/NFV design;

FIG. 14 illustrates more details of broadcast network slicing using the virtualized multi-channel-tenant broadcast sharing platform and SDN/NFV design;

FIG. 15 illustrates view 5G Core release 16 and shared broadcaster core network entities interworking enabling convergence and new industry verticals; and

FIG. 16 illustrates use cases of broadcast channel sharing, interworking broadband and 5G convergence using technology and methodology disclosed under orchestration of broadcast market exchange entity.

### DETAILED DESCRIPTION

The term Spectrum Consortium is used herein to collectively represent all the broadcasters that have entered into channel sharing agreements to voluntarily explore ATSC 3.0 in United States. A next generation multi-tenant-channel virtualized broadcast platform is depicted in 100. This 100 is one example of intelligent system architecture enabling broadcast spectrum pooling and sharing of channels, broadband and 5G convergence.

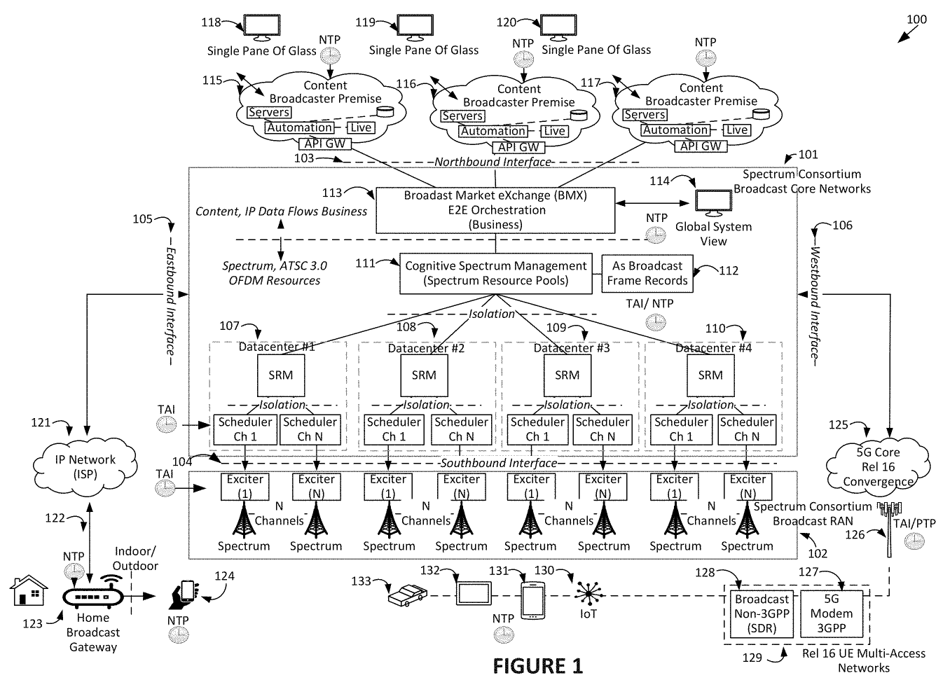

FIG. 1 illustrates one example of new intelligent system architecture enabling broadcast spectrum pooling and sharing of channels, broadband and 5G convergence. FIG. 1 provides a high-level introduction of a platform 100 which is to be followed by discussions later with additional drawings each focusing on specific areas of the platform 100 in more detail. As illustrated in FIG. 1, the platform 100 includes a shared broadcast core network 101 and a broadcast radio access entity 102.

The spectrum consortium uses the shared broadcast core network 101 which can include four regional datacenters 107, 108, 109, 110 serving regions of United States in this example. However, those skilled in the relevant art(s) will recognize that a different number of regional datacenters are possible without departing from the spirit and scope of the present disclosure. As illustrated in FIG. 1, the shared broadcast core network 101 includes four defined interfaces northbound 103, southbound 104, eastbound 105 and westbound 106 as illustrated in FIG. 1.

In the exemplary embodiment illustrated in FIG. 1, each of the regional datacenters 107, 108, 109, 110 serves N shared 6 MHz broadcast channels licensed to broadcasters in cities in geographic regions of the United States to implement a cohesive national platform, while serving the local communities of license. As illustrated in FIG. 1, each of the of the regional datacenters 107, 108, 109, 110 includes N-broadcast schedulers to build the digital ATSC 3.0 waveform instructed by a spectrum resource manager (SRM). This digital signal is then sent over southbound interface 104 into the broadcast radio access entity 102 which includes an exciter to modulate and to convert this digital signal to analog radio wave for transmission in the broadcast spectrum.

As illustrated in FIG. 1, each of the regional datacenters 107, 108, 109, 110 includes one spectrum resource manager (SRM) which responsible for managing the N-broadcast schedulers that each build ATSC 3.0 digital waveforms. The SRM is responsible for establishing and maintaining a spectrum resource pool for each of the N shared 6 MHz broadcast channels.

There is a known spectrum sharing algorithm defined by equations that exactly describes the number of resources in a spectrum pool in a 6 MHz channel. Each resource unit is equated to and is represented by one ATSC Sample (T) period, which can be considered an atomic unit. The number of sample periods (T) per second is a constant in ATSC 3.0 in a 6 MHz channel. Exactly 6,912,000 sample (T) periods per second always occurs in 6 MHz and is a constant.

Moreover, there is a correlation between the number of resources required to build each type of ATSC 3.0 frame. ATSC 3.0 broadcasting is simply a continuous sequence of ATSC 3.0 frames in a 6 MHz channel. In general, the number of resources required to build a frame is also a function of type and robustness of waveform selected and has many variables.

However, the sharing algorithm accounts for all details to both establish and maintain accurate spectrum pools. Independent of type of OFDM waveform type or number of virtual users sharing a frame as a function of the OFDM frequency and time domains.

Some resources from the spectrum pool can be used to support the content and/or data transmission directly while others are used for necessary overhead in a frame such as for pilots to estimate channel for receiver in frequency domain, guard interval in time domain, etc. A frame begins with bootstrap and preamble symbols. All users in a frame benefit from and will share equally in this overhead which is used for initial synchronization and low-level signaling in each frame. The resources used in each frame can be accurately accounted for and analyzed on a symbol by symbol basis for all users of a frame.

Therefore, if N broadcasters have agreed to share one 6 MHz channel the exact distribution of the constant 6,912,000 samples (T) each second between broadcasters can be accounted and validated openly. This to ensure integrity of platform 100 and trust of spectrum consortium licensed broadcasters and to encourage monetization for new business models.

All licensed spectrum resources samples (T) in a pool are considered commodity items in a free market under the BMX orchestration entity 113. This is a granularity of 597,196,800,000 samples (T) or resource units each day in one 6 MHz channel. The platform 100 can account for each and the free market can decide its use.

Moreover, each of N-broadcast schedulers is isolated and has no knowledge of the other N-broadcast schedulers or channels managed by their respective SRM. The spectrum pools are established and maintained by the SRMs in each of the regional datacenters 107, 108, 109, 110. Each SRM is isolated has no knowledge of the other SRMs in other regional datacenters 107, 108, 109, 110.

The cognitive spectrum management (CSM) entity 111 is centrally located and has a consolidated view of spectrum resource pools of each of the regional datacenters 107, 108, 109, 110 under the management of each SRM. The as broadcast frame records 112 contains the metrics, metadata and timestamps, etc. used by the BMX orchestration entity 113 to validate all resources used from all spectrum pools to build ATSC 3.0 frames. Against SLAs and for development of charging records, etc. this is then presented on broadcast premise on 118, 119, 120.

The CSM entity 111 abstracts technical details of management of spectrum pools from and provides services to the BMX orchestration entity 113. The BMX orchestration 113 is responsible for the exchange-to-exchange (E2E) orchestration of IP content and/or data flows into and on the platform 100. The BMX orchestration entity 113 has the business view and ways or policy to monetize spectrum resources for all users under the governance of the spectrum consortium and SLA agreements with the broadcaster premises 115, 116, 117 for example.

The broadcaster premises 115, 116, 117 are illustrated in FIG. 1. However, those skilled in the relevant art(s) will recognize that a different number of virtual broadcaster premises are possible without departing from the spirit and scope of the present disclosure. The broadcaster premises 115, 116, 117 under the BMX orchestration entity 113, send content, IP data flows over the northbound interface 103 using Rest Application Programming Interfaces (APIs) via API gateways (GWs) under BMX orchestration. The broadcaster premises 115, 116, 117, have local traffic and automation systems for internal routing of content including live and/or data. The premise automation system can also be interfaced via the northbound interface 103

Each of the broadcaster premises 115, 116, 117 has a common Graphic User Interface (GUI) also referred to as a single pane of glass 118, 119, 120. The single pane of glass 118, 119, 120 represent single points to control, monitor and validate their individual resources on shared channels on the platform 100 in real-time or as reports executing their business models. This also includes monitoring of the revenue charges to another entity that has used some of their resources under SLA via BMX orchestration as a commodity in a free market. Each of the broadcaster premises 115, 116, 117 is totally isolated from view of other of the broadcaster premises 115, 116, 117 on the platform 100. The global system view 114 is available only under the governance of spectrum consortium to the independent network operators of the platform 100.

The platform 100 system abstraction hierarchy described herein is strictly enforced and the BMX orchestration entity 113 knows only of the CSM entity 111. Any query of a specific channel resources flows from the CSM entity 111 to the SRM onto the N-broadcast schedulers in the regional datacenters 107, 108, 109, 110. These abstractions and isolations are strategic to the operation of the platform 100.

One example is the benefits of ATSC 3.0 channel bonding of the resources of two 6 MHz channels managed by an SRM with each of the N-broadcast schedulers being agnostic of other broadcast schedulers. Channel bonding can be used to increase the capacity or robustness of a service to a UE over that possible of only a single channel. This, when two orchestrated synchronized 6 MHz channels are received simultaneously.

The intelligence provided in shared core network 101, specifically the BMX orchestration entity 113, can be used to converge broadcast services with broadband and/or 5G for each individual broadcaster tenant. The eastbound interface 105 of the shared core network 101 via the IP network 121 and an ISP 122 can manage a broadcast home gateway 123 placed in the consumers home.

The broadcast home gateway 123 can be the anchor point for the relationship with the consumer and broadcaster in a mobile society. The registration and authentication of the user/s of the broadcast home gateway 123 is provided by the shared core network 101. Various databases in the shared core network 101 then store important information on the consumers interest, etc. These databases can include preferences for content and/or the television programs consumed, and ads watched, etc. This data mined is then stored in the shared core network 101 for each broadcaster tenant and consumer relationship.

The broadcast home gateway 123 can include Wi-Fi allowing consumers to interact with content using a tablet and/or phone while at home. The personal interest of these consumers can be used to pre-position content and spot commercials via an IP Network 121 of, for example, an Internet service provider (ISP), and then side loaded seamlessly from the broadcast home gateway 123 onto a registered personal device in home.

When consumer leaves the home and goes outdoors with a device 124 in hand, the continuity of programming is seamless. The spot ads loaded onto the device 124 via the broadcast home gateway 123 can be triggered for seamless personalized ad insertion. For example, a 30 second advertisement for a car can be replaced with a make and model that fits consumer profile seamlessly in live programming such as a sports event using the shared core network 101 and can be different for different users. Other advertisement in same commercial break can be global and viewed by all.

The westbound interface 106 of the shared core network 101 enables the BMX orchestration to interwork or converge with a 5G core network 125 under SLA for a broadcaster with a business model with 5G MNO. The 5G core network 125 in 3GPP release 16 has a new service-based architecture (SBA) with REST-API's. This is designed to support interworking of 3GPP and Non-3GPP access networks such as broadcast in the future. More details of this broadcast 5G convergence is discussed later.

Broadcast 5G convergence can be a mutually beneficial business proposition to both broadcaster and MNO and is consumer friendly. The broadcaster can receive unicast 5G services to support software applications broadcaster has installed on the 5G reception device. Moreover, the software applications have complementary back office server support on the shared broadcast core network 101. Then, broadcast operates as a new vertical industry to the 5G core network 125.

The MNO can receive broadcast services from the platform 100 for in demand content and/or data that would congest the 5G core network 125 and be efficiently handled with broadcast. Then MNO operates as a new vertical industry to the broadcast core network 101. Both use cases are under SLA between broadcaster and MNO using intelligent interworking of the shared core network 101 and the 5G core network 125.

The broadcast radio access entity 102 includes radio access networks. The 5G unicast services use 126 radio access networks. Most important 3GPP release 16 supports a dual connected user UE receiver 129. This mode supports both 3GPP and Non-3GPP access networks which are illustrated as 5G modem 127 and broadcast non-3PP demodulator 128 in FIG. 1.

The interworking core networks for convergence between the shared core network 101 and the 5G core network 125 can also enable convergence on the UE. The software defined radio SDR 128 demodulator chip can be synergistic in enabling tight convergence and consumer friendly experience. Additional UE devices and use cases can support the dual connection convergence 130, 131, 132, 133 with the dual connected user UE receiver 129 and intelligence in both core networks supported SLA business agreements.

Also, 3GPP TS 23.793 study reports on access traffic steering, switching and splitting between 3GPP and Non-3GPP access networks in the 5G system architecture release 16. This study provides details on dual conn UE for both 3GPP and Non-3GPP access networks. This is synergistic to the dual connected user UE receiver 129 indicating the time is right for broadcast 5G convergence in release 16 with the correct platform.

Also, essential in the platform 100 to ensure channel sharing without contention between users for resources and to achieve flexibility and efficient spectrum utilization (monetization) is use of the common time references shown. The 6 MHz broadcast spectrum is licensed for exactly 86,400 seconds each day. The orchestration of all spectrum pools resource usage progresses by a constant 6,912,000 Samples (T) in each second period for each shared 6 MHz channel. The physical layer uses Time Atomic International (TAI) reference which is monotonically increasing with no leap seconds and available from GPS or as IEEE 1588 PTP over broadband.

The Network Time Protocol (NTP) references enables the content and/or data flows of the broadcaster premises 115, 116, 117 in spectrum pools to share the finite spectrum resources of 6 MHz channels efficiently. The broadcaster premises 115, 116, 117 and the BMX orchestration entity 113 can include NTP which is locked to the TAI second cadence.

This synchronous deterministic network timing of the platform 100 permits each of the broadcaster premises 115, 116, 117 to have deterministically scheduled virtual broadcast channels concurrently. These virtual channels are termed broadcast network slices under BMX orchestration in a shared 6 MHz channel and occur without collisions or contention for resources. This deterministic feature of the platform 100 results in increased spectrum efficiency and dynamic programmability over the 86,400 seconds in a day on a market driven basis.

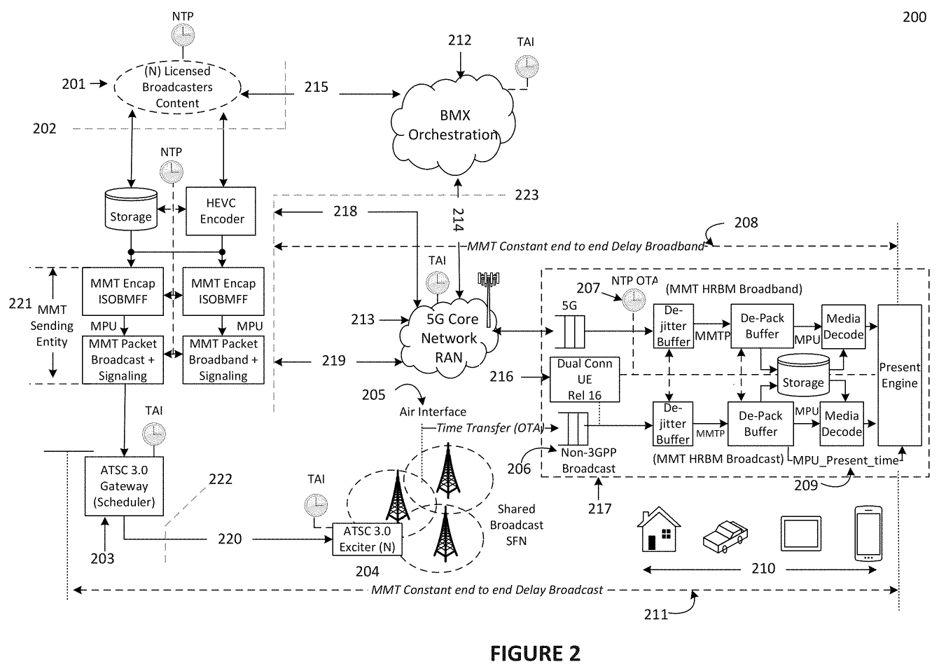

FIG. 2 illustrates one example of intelligent system architecture and the timing of IP content flows for broadcast and 5G convergence. The exemplary embodiment illustrated in FIG. 2 illustrates N-licensed broadcasters 201 and the end to end platform timing model for a platform 200. The platform 200 can represent an exemplary embodiment of the platform 100 as described above in FIG. 1.

In the exemplary embodiment illustrated in FIG. 2, the physical layer timing uses TAI and the IP content flow timing uses ISO MPEG media transport (MMT) 23008-1 standard and NTP. The ISO MMT 23008-1 supports seamless broadcast and broadband heterogeneous networking. This MMT timing is further described in U.S. patent application Ser. No. 16/036,5790, filed Jul. 16, 2018, which is incorporated herein by reference in its entirety.

ISO MMT 23008-1 requires NTP time references on both transmit side including the broadcasters 201 and the MMT send entity 221 and the dual connected receiver 217 as shown as NTP OTA 207. The scheduler 203 has the responsibility of serving accurate time NTP to the dual connected receiver 217. The scheduler 203 inserts calibrated TAI timestamps and metadata to be accurate at instant signal reaches antenna air interface 205. The scheduler 203 sends timestamps and metadata across the southbound interface 222 on fronthaul 220 to exciter 204.

The calibrated timestamps and metadata at 205 are then propagated and received by broadcast receiver 206. Given speed of light propagation of radio waves the small propagation latency between the antenna air interface 205 and NTP OTA 207 is acceptable for the accuracy required. The dual connected receiver 217 then converts the TAI timestamps and metadata into NTP at to provide the NTP OTA 207.

The ISO MMT 23008-1 supports tight control of playback presentation time 209 using NTP on UE on the dual connected UE 216. This independent of the transport networks used by the exciter 204 and or the 5G core 213 received by the dual connected UE 216.

This is achieved by a defined hypothetical receiver buffer model (HRBM) in ISO MMT 23008-1. The HRBM chains are shown in the dual connected receiver 217 but will not be described in further detail. The HRBM chains are further described in the ISO MMT 23008-1 standard which is incorporated by reference herein in its entirety. This HRBM works by ensuring a constant end to end delay broadband 208 and end to end delay broadband broadcast 211.

The shared BMX Orchestration entity 212 is shown interworking with broadcasters 201 via an interface 215 over the northbound interface 202 and via an interface 214 over the westbound interface 223 into the 5G core 213 both having TAI. The broadcasters 201 bring content IP flows across northbound interface 202 under BMX orchestration using NTP. The interface 218 via westbound interface 223 shows a 5G MNO as a new vertical industry bringing content and/or data onto the broadcast platform. Similarly, an interface 219 shows broadcasters 201 via westbound interface 223 as new a vertical industry bringing IP content and/or data unicast onto the 5G core 213 5G. Unicast 5G services for broadcasters 201 having back office server support from the shared BMX Orchestration entity 212 for software applications from the broadcasters 201 on the dual connected receiver 217. The dual connected UE 216 under 5G release 16 supports many devices 210 and various use cases are to be described in further detail below.

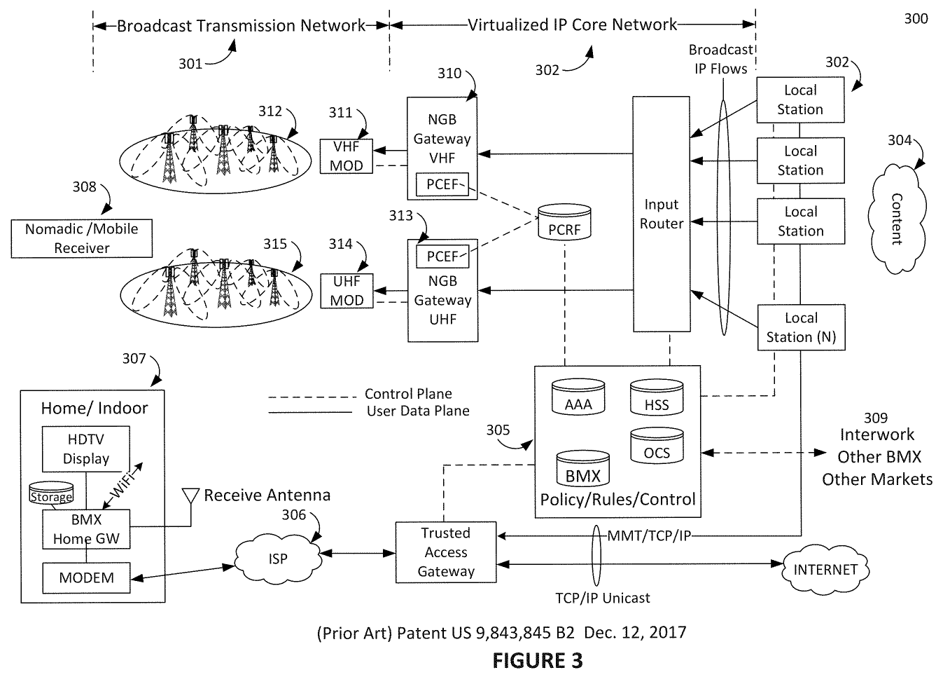

FIG. 3 illustrates the BMX entity and system architecture before wireless SDN/NFV and cloud computing architectures emerged as described in U.S. patent application Ser. No. 14/092,993. At the time of this patent application, bare metal hardware was used long before the emergence of SDN/NFV and cloud computing and ATSC 3.0. These general concepts are now evolved and extended herein with new capabilities including a new fundamental algorithm for spectrum pools and channel sharing with ATSC 3.0 and convergence 5G.

As illustrated in FIG. 3, content 304 and several local broadcasters 302 bring IP flows onto a platform 300 which has a core network 302 and a broadcast transmission network 301. The content 304 is routed to a gateway 310 for VHF band and uses modulator 311 and Single Frequency Network (SFN) 312. The content 304 is also routed to a gateway 313 for UHF band and uses modulator 314 and Single Frequency Network SFN 315. There is also interworking with other BMX markets 309.

The BMX home gateway 307 is managed over ISP 306 using intelligence BMX 305. A nomadic receiver is shown 308. This platform 300 as illustrated in FIG. 3 was described using 3GPP 4G long before the emergence of 5G.

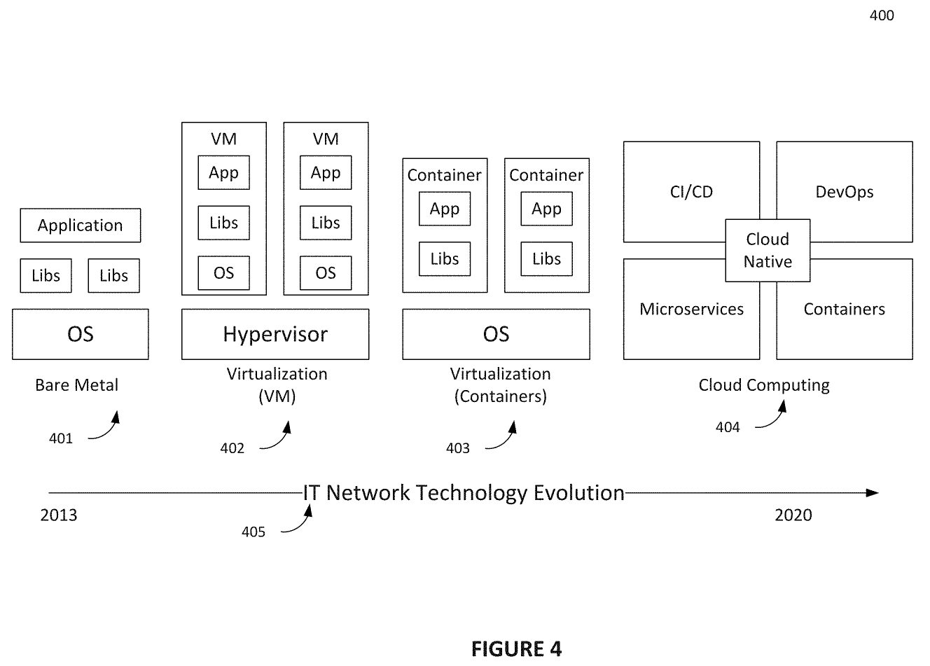

FIG. 4 illustrates timeline of evolution IT computing and networking from bare metal to virtualization (VM, container) to cloud native computing. FIG. 4 illustrates a timeline 405 of evolution in IT networking technology. The hardware or bare metal only 401 circa 2013 has progressed first using virtualization and virtual machines VM and hypervisor 402 to virtualization using containers 403 to current SDN/NFV cloud computing system 404. The disclosure herein describes new BMX architecture, methodology, and cloud computing herein which can be aligned with 5G.

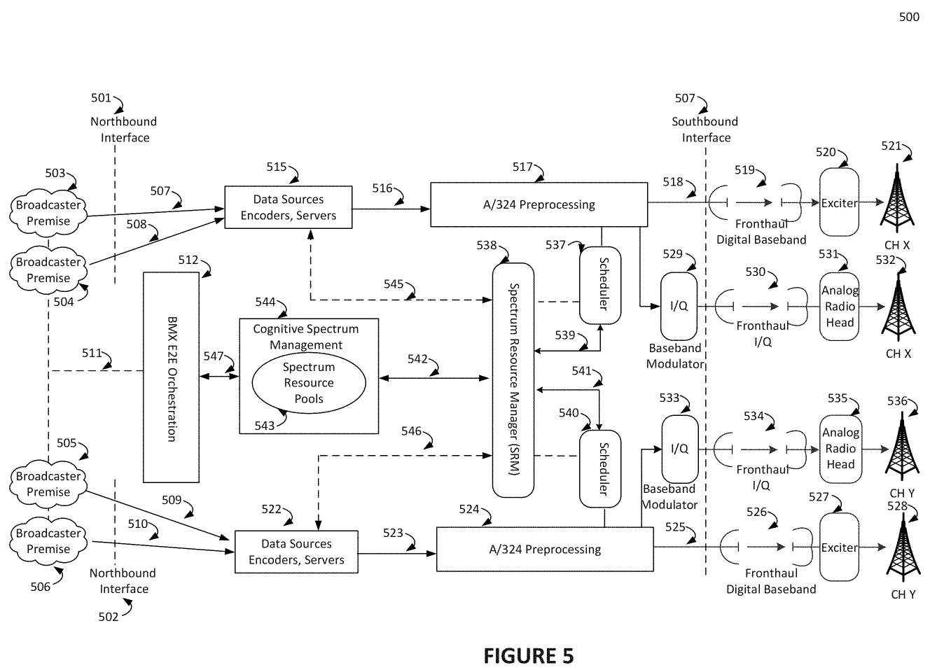

FIG. 5 illustrates the high-level end to end architecture of the entities and the establishment of broadcast spectrum resource pools and channel sharing. FIG. 5 illustrates an end to end system architecture 500 over northbound interface 501, 502 from broadcaster premise 503, 504, 505, 506. The entity responsible for establishing spectrum resource pools is the spectrum resource manager (SRM) entity 538. The SRM entity 538 has expert theoretic knowledge of ATSC A/321, A/322 standards and exact number of resource samples (T) required to build any ATSC 3.0 frame. The exact actual number of resource samples (T) used will vary slightly from theoretic based on statistics of the traffic and decisions made by schedulers 537, 540.

Therefore, scheduler 537 communicates scheduling decisions over an interface 539 to the SRM entity 538 for establishing and maintaining spectrum resource pool for channel X. Scheduler 540 communicates scheduling decisions over an interface 541 to the SRM entity 538 for establishing and maintaining spectrum resource pool for channel Y.

The spectrum resource pools for channel X and channel Y is communicated over an interface 542 to the centrally located cognitive spectrum management (CSM) entity 544. The images of all spectrum resource pools 543 of all shared channels is in CSM entity 544.

The CSM entity 544 abstracts the details of the OFDM physical layer used in spectrum pools from the BMX orchestration entity 512. The CSM entity 544 supplies services to BMX orchestration entity 512 over an interface 547. The BMX orchestration entity 512 only has knowledge of the business and how to monetize spectrum resources. The BMX orchestration entity 512 relies on the CSM entity 544 for all insight of available resources in a pool and all resources used by the broadcasters 503, 504, 505, 506 sharing channels which is reported in the as broadcast frame records 112 as described above in FIG. 1.

The BMX orchestration entity 512 authenticates and authorized the broadcasters 503, 504, 505, 506 via interfaces 511 when a request is made to bring content and/or data onto the northbound interfaces 501, 502. The BMX orchestration entity 512 commutates via the interface 547 to the CSM entity 544 about insight into spectrum pools 543. The CSM entity 544 reports on instantaneous availability of resources owned by the broadcasters 503, 504, 505, 506 in the spectrum pools 543 before granting the request for access. The number of spectrum resources samples (T) available in a second is constant for each 6 MHz channel and when sharing channel resource usage can be tracked accurately.

The broadcaster premise 503 and 504 sharing channel X send content over an interface 507, 508 to data sources, encoders, servers 515. The data sources, encoders, servers 515 process the content and sends this content by an interface 516 to the A/324 preprocessing 517. The A/324 preprocessing 517 is under control of the scheduler 537 and builds a digital baseband ATSC 3.0 frame. This is output on an interface 518 to the fronthaul digital baseband 519 to exciter 520 at transmitter site. The digital baseband signal is modulated and converted into an analog radio signal and broadcast using a radio access network 521.

The broadcaster premise 505 and 506 sharing channel Y send content over an interface 509, 510 to data sources, encoders, servers 522. The data sources, encoders, servers 522 process the content and sends this content by an interface 523 to the A/324 preprocessing 524. The A/324 preprocessing 524 is under control of the scheduler 540 and builds a digital baseband ATSC 3.0 frame. This is output on an interface 525 to the fronthaul digital baseband 526 to exciter 527 at transmitter site. The digital baseband signal is modulated and converted into an analog radio signal 527 and broadcast using radio access network 528.

The efficient use of all spectrum resources is very important to the broadcasters 503, 504, 505, 506 especially when sharing a channel on the end to end system architecture 500. The robustness and capacity selectable for virtual channel is very flexible and directly proportional to the selection of the LDPC code rate and constellation. The ATSC 3.0 standard has 24 different LPDC codes and 6 constellations for a total of 144 options available for a virtual channel. These selections enable a robustness from −6 dB SNR to +33 dB SNR and a capacity from ˜1 Mbps to 57 Mbps when using total 6 MHz channel.

Each of the broadcasters 503, 504, 505, 506 selects 1 of 144 combinations of robustness and the pool resources will be tracked and reported. However, for efficient operation the scheduler 537, 540 via the SRM entity 538 can in closed loop control of data sources, encoders, servers 515 and data sources, encoders, servers 522 via an interface 545 and an interface 546, respectively. The physical layer resource awareness from the schedulers 537, 540 can control and/or throttle data rates slightly to ensure content is encoded and encapsulated by A/324 preprocessing 517, 524 with the best efficiency possible. The awareness from the schedulers 537, 540 of data sources, encoders, servers 515, 522 also ensures dynamic opportunistic use cases for excess resource capacity and revenue from selling resources to other entities in a free market under BMX orchestration entity 512.

Also, when a request is made from broadcaster premise to bring content and/or data onto the end to end system architecture 500, decisions other than a binary decision are possible for the BMX orchestration entity 512. The SLA established and policy running for a broadcaster may allow optimization and slight throttling of data sources, encoders, servers 515, 522 to fulfill the request efficiently. An automated intelligent adaptable programmatic platform results in flexibility for a licensed broadcaster sharing a channel to monetize their spectrum resources 86,400 seconds a day.

There is also additional flexibility shown to enable a software defined radio SDR. The A/324 preprocessing 517, 524 shows option of a I/Q baseband modulator 529, 533 via a I/Q fronthaul 530, 534 to an analog radio head 531, 535 for channel X 532 or channel Y 536.

The I/Q modulator 529, 533 signals are fully modulated, and the analog radio head 531, 535 simply converts to an analog signal. The radio head 531, 535 is total agnostic to the type of waveform and this allows different waveforms for different use cases to be transmitted on a frame by frame basis which is supported by A/321 bootstrap. The bootstrap is further described in U.S. patent application Ser. No. 15/648,978, filed Jul. 13, 2017, now U.S. Pat. No. 10,158,518, which is incorporated herein by reference in its entirety.

The flexibility of SDR can then adapt to different waveforms broadcast. Example a waveform for a battery constrained IoT device will be different being optimized for this use case. The tradeoff is the data rate required on fronthaul to support I/Q 530, 534 is higher than digital baseband 519, 526.

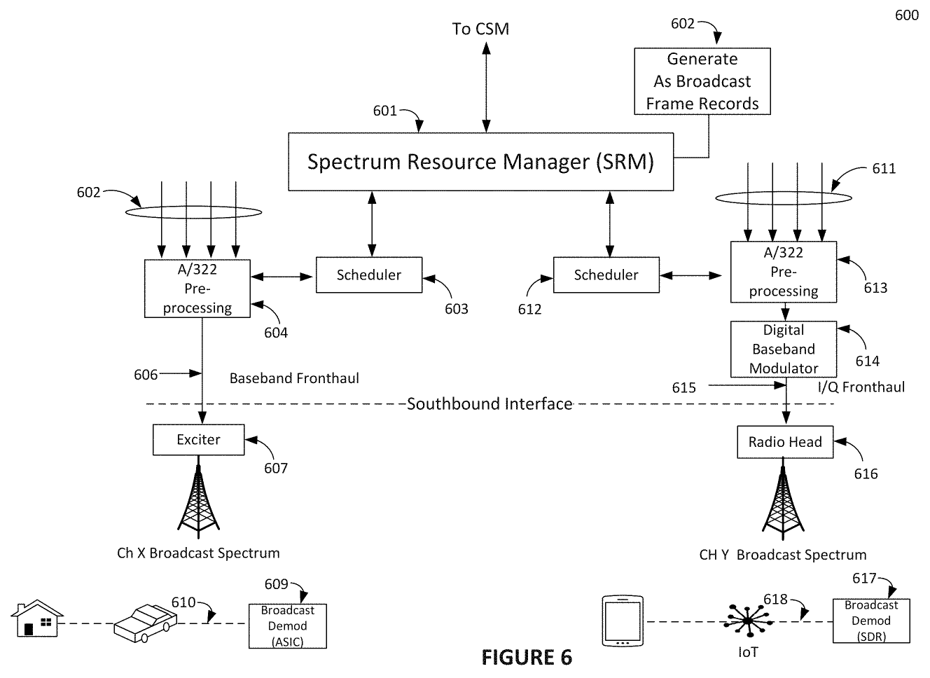

FIG. 6 illustrates broadcaster channel assignment as function of spectrum physics and use case for best resource efficiency BMX orchestration. In United States the licensed broadcast is between broadcast channel (Ch) 2 through Ch 36 and spans low Very high frequency (VHF), high VHF and Ultra high frequency (UHF) spectral frequency bands. Generally, this broadcast spectrum is not fungible due to physics, but some frequency bands will be more efficient for certain use cases.

The traditional method in a country is for a regulator entity, such as the FCC to provide an example, to license a broadcaster a fixed channel assignment and in United States between Ch 2 through Ch 36. The laws of physics dictate some uses cases such as fixed home reception and/or vehicle or public transportation may be most efficiently served with a channel in the VHF band while portable battery powered use cases including handheld are best served with channel in UHF band.

A platform 600 as illustrated in FIG. 6 includes flexibility to mitigate the regulator fixed channel assignment using BMX orchestration in a free market. The spectrum consortium of broadcasters in United States have license in Ch 2 through Ch 36 in spectrum pools under SLA and channel sharing agreements. In the exemplary embodiment illustrated in FIG. 6, channel X is operating in VHF band and channel Y in UHF band in this example.

As illustrated in FIG. 6, the SRM 601 manages scheduler 603 which controls A/322 preprocessing 604 which builds digital baseband signal 606 sent to exciter 607 to broadcast on channel X in VHF band. In the exemplary embodiment illustrated in FIG. 6, this broadcast is sent to a broadcast demodulator chip 608 for delivery to fixed and vehicle use cases 610.

Similarly, the SRM 601 manages scheduler 612 which controls A/322 preprocessing 613. A digital baseband demodulator 614 builds a I/Q digital signal 615 sent to radio head 616 to broadcast on channel Y in UHF band. In the exemplary embodiment illustrated in FIG. 6, this broadcast is sent to a broadcast demodulator SDR chip 617 for delivery to battery powered use cases 618.

As described above, the BMX orchestration entity is responsible for the business and efficient use of all spectrum resources. The SLA and policy on the BMX orchestrations has assigned the broadcasters with a fixed and/or vehicle service use case to channel X represented by the inputs 602 to A/322 preprocessing 604. The broadcasters with battery powered service use cases are assigned channel Y represented by the inputs 611 to A/322 preprocessing 613.

This flexibility mitigates the fixed static channel assignment by the regulator entity and allows the free market to best optimize the spectrum efficiency and revenues. Remember, the platform orchestration is flexible and can change assignment on a frame by frame and/or use case by use based on the SLA and policy on BMX which is controlled by broadcasters. This, when all spectrum resources are treated as a commodity in a free market driven and considering the physics of radio propagation.

The individual broadcaster decides how to operate, and this is reflected in SLA and policy for this individual broadcaster. The policy is based in software and can be changed in future by broadcaster using free market forces and innovation to extract the most value from the broadcast spectrum. The broadcast band in United States was assigned 70 years ago for one specific use television to the home, a way to quickly reach citizens of nation, since then things have changed in United States.

The as broadcast frame records are generated 602 which correlates each broadcaster unique identifier (ID) to a unique IP flow and unique User Datagram Protocol (UDP) port number and exact number of resources used on a virtual broadcast channel. These records are then processed by BMX and charging information is added, timestamps, etc. The real-time view and/or reports of platform operation appear on the single pane of glass GUI 118, 119, 120 at the broadcaster premise as described above in FIG. 1. To control and validate operation and reconcile business transactions on platform using databases in the shared broadcast core network.

Allowing the fixed number of spectrum resources owned by a broadcaster to be distributed over different shared channels is innovative which can be handled by automation in a free market. An automated intelligent adaptable programmatic platform results in flexibility for a licensed broadcaster sharing over several channels to monetize their spectrum resources 86,400 seconds a day.

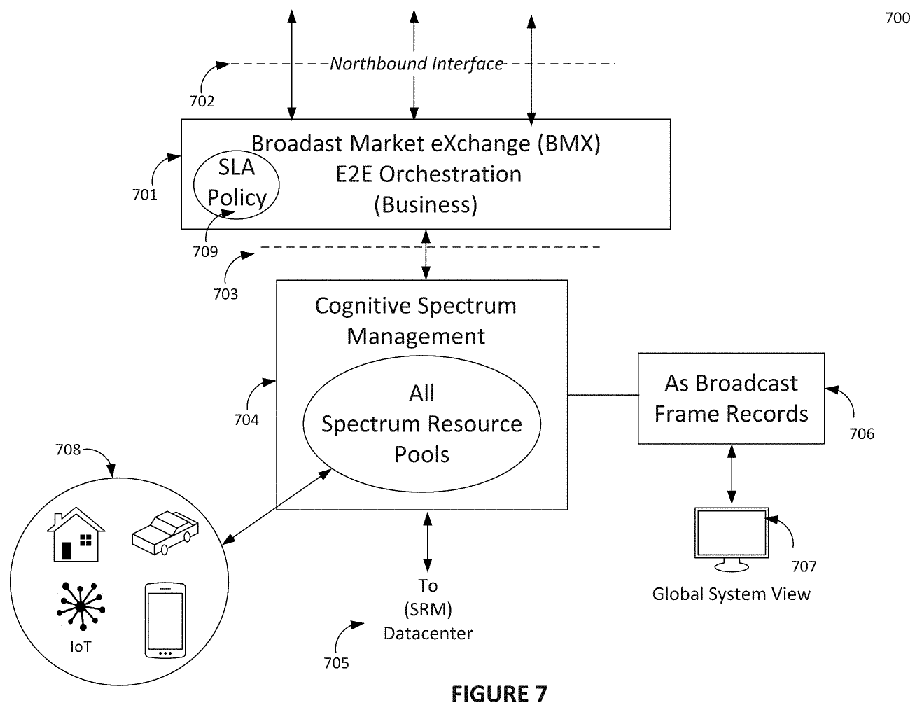

FIG. 7 illustrates a context aware network using BMX orchestration driven by policy reflecting will of broadcaster under SLA. As illustrated in FIG. 7, a platform 700 include a BMX orchestration 701 which contains the Policy and SLA 709 for each broadcaster. This reflects the broadcaster signed contract SLA for the Policy. For platform to operate and optimize their spectrum resources as a function of time, channel frequency bands, use case, open market commodity, etc. to maximize revenue for their virtual broadcast business model.

The context awareness is in the automated intelligence in the platform 700 can make decisions both programmatically and in real-time to increase revenue from the spectrum resources using free market principles in each 86,400 seconds of each day.

The BMX entity 701 communicates via an interface 703 with centrally located CSM entity 704 and all datacenters and SRM 705. The context awareness to the use case is shown 708 based upon the decisions CSM entity 704 makes for assigning resources. The context awareness is driven by policy 709. The selected shared channel is a function of use case. The policy can be different for each broadcaster and resource use cases. The SLA can be done on a fixed and/or best effort based on the instantaneous platform traffic statistics, this is a business discussion that is reflected in the policy software logic.

The as broadcast frame records 706 will validate all decisions made on platform by BMX orchestration 701. The records are filtered for each broadcaster premise and available via the northbound interface 702 at each broadcaster premise for his own interest. The records are stored unfiltered globally 707 for the platform network operator/s selected by spectrum consortium governance.

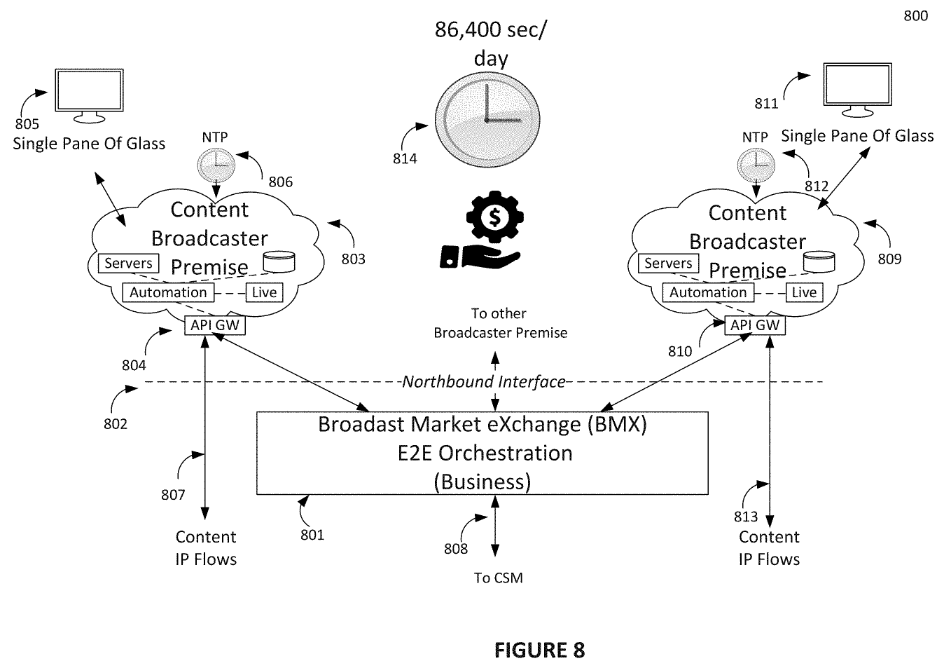

FIG. 8 illustrates BMX orchestration is 86,400 sec/day and is use or lose proposition for a broadcaster's spectrum resources each second. In one day an exact constant 597,196,800,000 Samples (T) are consumed in 6 MHz channel by a platform 800. The resource can be divided among (N) broadcasters per a channel sharing agreement and enforced by the platform.

The important thing to understand is the size of resource pool and usage per time is constant in 6 MHz channel and is independent of type of waveforms and/or number of users sharing 6 MHz channel. This is strictly a use it or lose it proposition for each broadcaster with resources in a spectrum pool as each second continuously ticks.

If the scheduler ever lacks enough content or data at any instant in time to complete a frame to broadcast. The scheduler as required in standard will insert as many dummy cells into as may symbols as required into a frame. This is wasteful inefficient and generates no revenue and should be avoided. Conversely, using any additional resources than allotted per unit of time is also strictly prohibited by 801.

The BMX 801 and the CSM 808 implement and enforce the resource distribution of each broadcaster 803, 809 on a frame by frame basis. The content or data using NTP timestamps 806, 812 flows via API GW 804, 810 over the northbound interface 802 onto the platform 800 via interfaces 807, 813.

As previously discussed in FIG. 5 the low-level resource awareness of the SRM or scheduled should be used in close loop control of the data source, encoder, server 545, 546 processing the content on the interfaces 807, 813. The platform automation can then throttle or control data rates to ensure spectrum resources are used most efficiently and completely and not for inserting dummy cells is the objective. Also, identifying data insertion opportunities within the real-time traffic and selling resources under SLA as a commodity using the broadcast market exchange.

The platform executes on basis of each broadcaster's signed SLA and policy running. Then BMX 801 reports openly all operational metrics on broadcast premise 805, 811. This reporting can include history of dummy cells inserted and hence efficiency as well as all revenue earned using broadcast market exchange automation as a function of time.

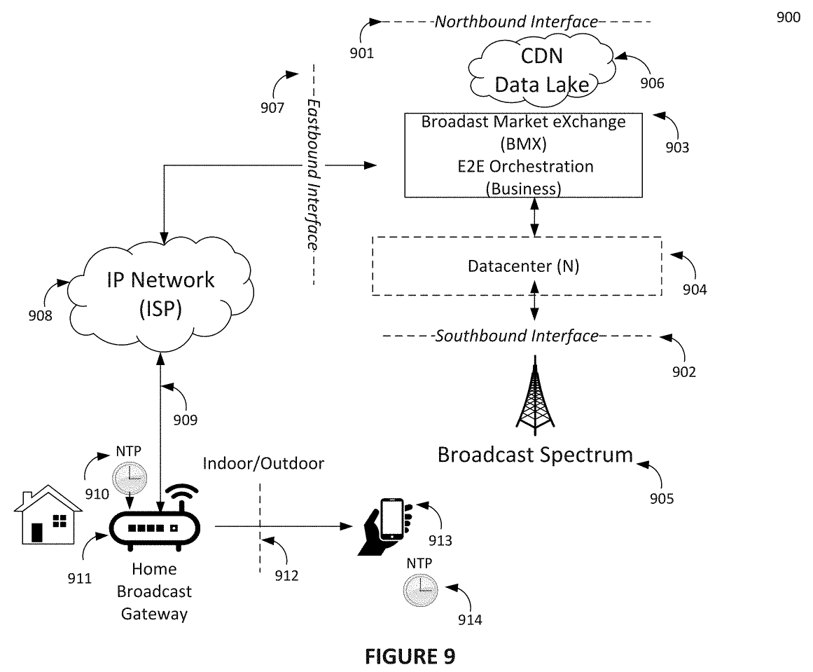

FIG. 9 illustrates the high-level view of eastbound interface from BMX orchestration entity to manage CDN or Data Lake and ATSC 3.0 home gateway via ISP. As illustrated in FIG. 9, a platform 900 includes the ATSC 3.0 home gateway 911 with NTP 910 communicating via IP Network 908 and ISP to the home 909.

The datacenter (N) 904 and southbound interface 902 and broadcast transmitter 905 and the northbound interface 901 is also shown in FIG. 9.

The Content Delivery Network and Data Lake 906 both under BMX orchestration 903 and using the eastbound interface 907. The CDN provides on demand video services to augment the over the air broadcast services received 905 receive on the ATSC 3.0 home gateway 911.

When ATSC 3.0 home gateway 911 is purchased and registered 903, it then authenticates each registered user in the home. The data lake 906 is used to load content and/or data files onto the ATSC 3.0 home gateway 911 either on demand or automatically using personal user profile stored in database 903.

The ATSC 3.0 home gateway 911 also includes Wi-Fi so registered users can interact with content and/or data directly using their tablet or phone while at home. The personal interest registered user is learned by the BMX orchestration 903 and this is used to automatically pre-position content and spot commercials via the IP Network 908 and ISP onto the ATSC 3.0 home gateway 911. Then this is side loaded seamlessly from ATSC 3.0 home gateway 911 via Wi-Fi onto a registered personal device 913 while in home.

When user goes outdoors 912 with a device 913 in hand the continuity of the broadcast programming is seamless. The commercials pre-loaded onto device via the ATSC 3.0 home gateway 911 can be individually triggered for seamless personalized ad insertion on the personal device 913 using NTP 914 as was discussed above in FIG. 2. As an example, during part of a commercial break a 30 second commercial for a car can be replaced on device 913 with car model that fits the user profile seamlessly during live programming such as a sports event. All other commercials in break are global and viewed by all. The broadcast signal can be used to trigger the personal insertion which can be different for each user profile.

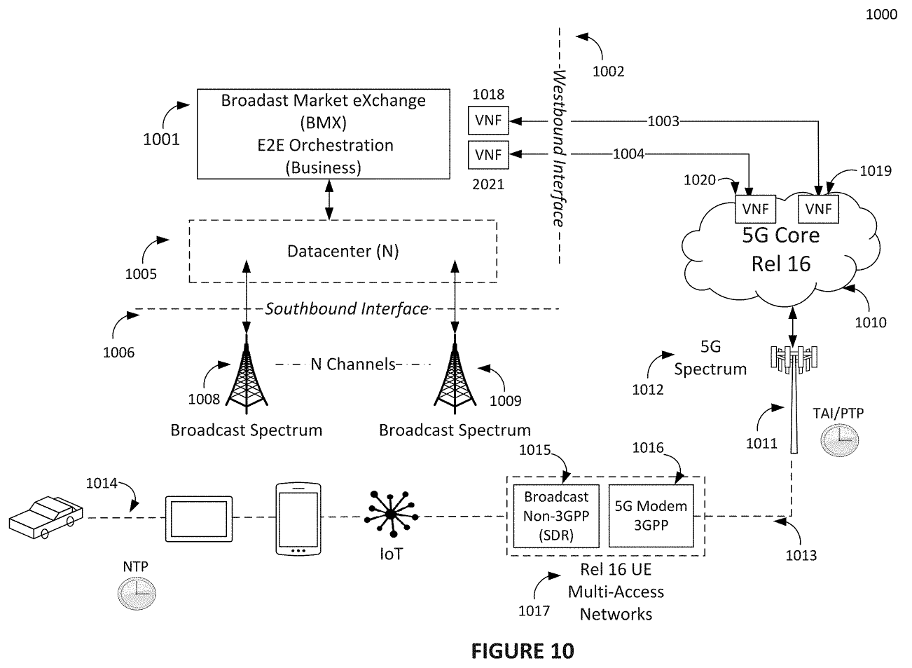

FIG. 10 illustrates the high-level view and concepts of layer 3 broadcast 5G convergence. In the exemplary embodiment illustrated in FIG. 10, a platform 1000 includes layer 1 radio access networking the broadcast and 5G unicast separately and optimized for best performance and efficiency.

Currently, methods in 3GPP such as eMBMS have convergence at layer 1. Broadcast signal is placed inside and shares the same 3GPP unicast frame structure which is optimized only for unicast. This is overall inefficient and has poor performance for the broadcast signal. Having separately optimized layer 1 signals and converging at layer 3 has both efficiency and performance advantages. Also, is synergistic now with 5G core new service-based architecture (SBA) and dual connection reception supported in release 16 to be discussed later.

The BMX orchestration 1001 and broadcast data center (N) 1005 are shown sending the generated broadcast signals over southbound interface 1006 to the (N) broadcast channels 1008, 1009 using the broadcast spectrum. The 5G core 1010 is shown sending generated unicast signals to the 5G RAN 1011 using the 5G spectrum 1012.

Dual connected user UE receiver 1017 supports 3GPP (5G) 1016 and Non-3GPP (Broadcast) 1015 access networks. The UE devices 1014 support this Dual connected user UE receiver 1017 using radio networks 1008, 1009 for broadcast and radio network 1012 for 5G spectrum.

The westbound interface 1002 depicts the interworking point between BMX 1001 shared broadcast core and 5G Core 1010 resulting in Layer 3 convergence.

The perspective of 5G MNO is discussed first and 5G will become a vertical on the broadcast platform. The virtual network function (VNF) 1019 sends or offloads 5G data traffic onto the broadcast platform via VNF 1018 shown. Using interface 1003 under an established SLA and policy running on both core networks. The 5G data traffic is then routed into broadcast data center (N) 1005 and a broadcast network slice is created, to be discussed later. The broadcast network slice signal is created in broadcast data center (N) 1005 and sent over southbound interface 1006 to radio networks 1008 or 1009 and the broadcast spectrum. The broadcast non-3PP demodulator 1015 receives signal on the dual connected user UE receiver 129.

The data that was sent by 5G core 1010 over interface 1003 under SLA was in demand by multiple UE as determined by 5G core 1010 network analytics. A decision is made to offload data and is more economic to use Broadcast as a Service BaaS under SLA than to congest the 5G unicast network. The broadcast band also has excellent propagation and penetration properties and serve wide areas. 5G core 1010 also determines it is more economic for distribution for large data files for firmware updates to many devices with broadcast. Than setting up millions of 5G unicast connections, a business decision reflected in SLA. The policy and charging running SLA on BMX orchestration 1001 automate the convergence and reporting. Having both broadcast and unicast on dual connected user UE receiver 1017 and the dual connected user UE receiver 1017 or 5G core 1010 make usage decisions based on network conditions or economics. This describes the power of layer 3 convergence with separately optimized heterogeneous layer 1 access networks.

Conversely broadcasters using BMX orchestration 1001 can use 5G unicast services under SLA and policy to support their business models. Broadcast becomes a vertical on 5G platform. Software applications loaded by broadcaster onto 1014 devices use unicast 5G services over 1004 between VNF 1021 and 1020 5G core and broadcast becomes a vertical on the 5G core platform. The broadcaster data is converted to unicast signals by 5G core 1010 and sent to 5G RAN 1011 and received 1016 on Dual connected user UE receiver 1017. Also, BMX orchestration 1001 provides back office servers to support software applications over 5G network received on dual connected user UE receiver 1017. The policy and charging running under SLA in the 5G core 1010 core automates the convergence and reporting. Having both broadcast and unicast on dual connected user UE receiver 1017 and the dual connected user UE receiver 1017 or BMX orchestration 1001 make usage decisions. Is the power of layer 3 convergence with separately optimized heterogeneous layer 1 access networks.

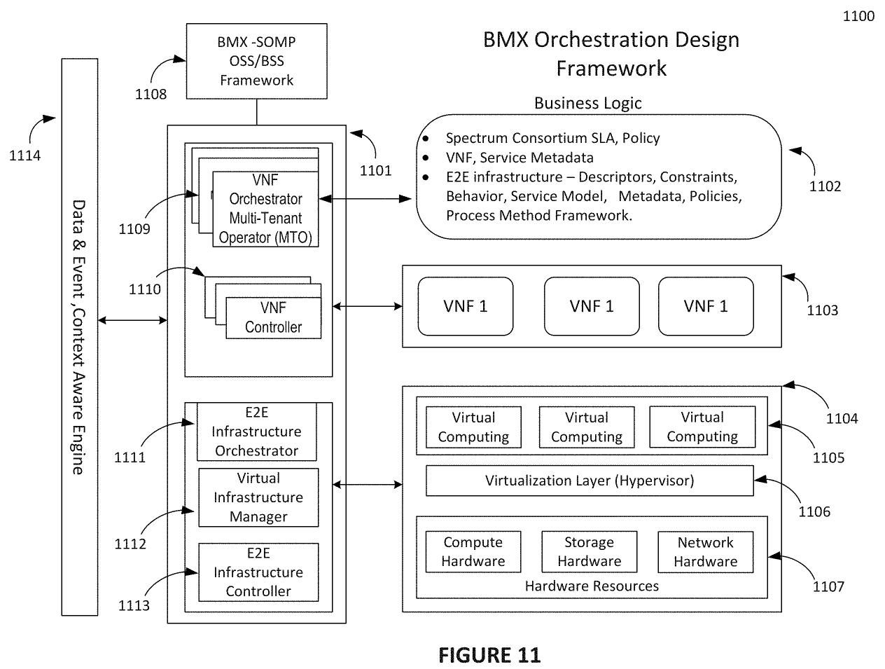

Broadcast 5G layer 3 convergence is mutually beneficial to broadcasters and 5G MNO and is a business decision reflected in SLA and policy. Both 5G core and broadcast are now using SDN/NFV to instantiate their architectures. This is discussed next beginning with the BMX (NFV) design framework 1100 in FIG. 11.

FIG. 11 illustrates the high-level view of broadcast market exchange orchestration design framework using virtual network functions. The term Network Function Virtualization (NFV) was first used by European Telecom Standards Institute ETSI in 2012 to first define an NFV framework model. The 3GPP 5G Core and the BMX Core NFV frameworks are now based on this industry accepted NFV reference model. This ETSI NFV model allows generic computer hardware to run Virtual Network Functions (VNF) which perform the same exact functions in software as fixed single purpose only hardware appliances which are now termed Physical Network Function (PNF). A system such as the BMX broadcast platform supports hybrid both VNF/PNF under SDN/NFV.

The ETSI model has three high-level blocks accepted by industry. The first high-level block is a Network Function Virtualization Infrastructure (NFVI) block 1104. The general computer hardware 1107 is used to host the virtual machines compute, storage and networking. The software abstraction of the virtualization layer 1106 makes virtualization possible and the virtualized computing machines 1105 are in the NFVI block 1104.

Next, the second high-level block is ETSI Virtualized Network Function VNF block 1103. This is the software implementing a VNF using the NFVI 1104. Finally, the third high-level block is the ETSI Management and Orchestration MANO block 1101. The MNO 1101 interacts with the 1104 block via Virtual Infrastructure Manager (VIM) 1112 and E2E orchestrator 1111, and E2E Controller 1113.

The MANO VNF controllers 1110 manage the VNF 1103. The MANO multi-tenant NFV Orchestration 1109 is responsible for tenant service orchestration. Multiple VNF can be linked or chained together to create a broadcast service for a broadcaster. Multiple VNF linked together forms the basis of a Broadcast Network Slice. The other blocks BMX-Symphony Orchestration Management Platform (BMX-SOMP) and the Operation Support Systems (OSS) and Business Support Systems (BSS) are all 1108. Finally, the Data & Event, Context Aware Engine 1114 is AI driven intelligence.

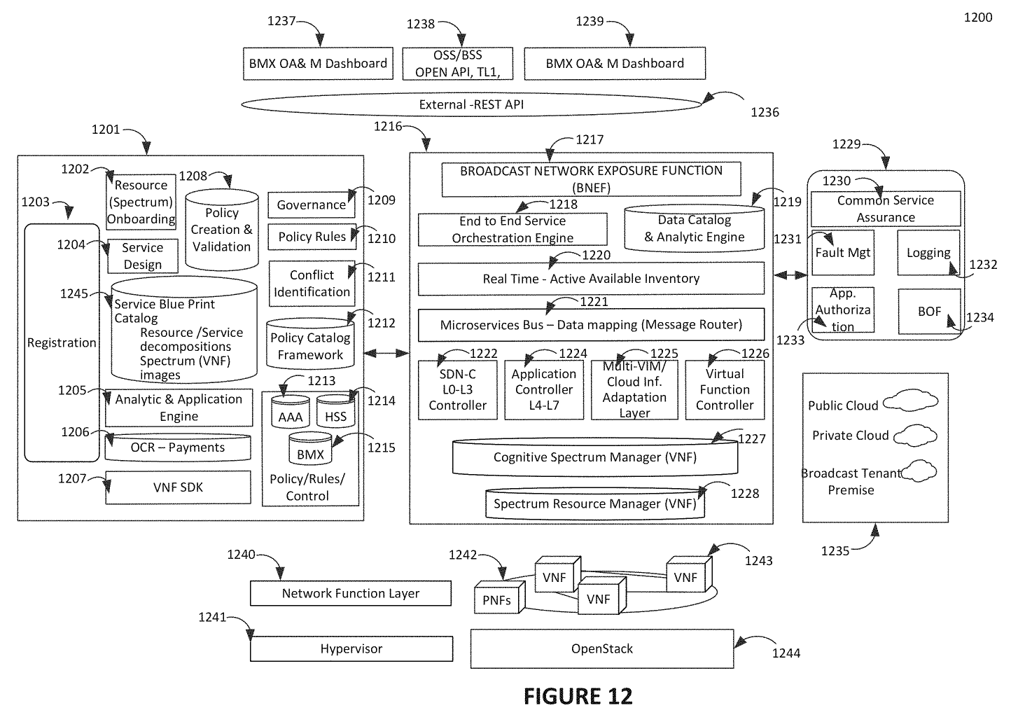

Those skilled in the art will see the relationship to the ETSI NFV model in 1100. Next, FIG. 12 illustrates the high-level view of broadcast platform design framework using software defined networking (SDN) and network function virtualization (NFV).

First, the term SDN is defined briefly. SDN abstracts or separates the control plane from the packet forwarding plane of all SDN controlled IP switches, Routers, Gateways, etc. The control plane is then centrally located in SDN controller that has software that makes all decisions for end to end packet flows from central managed location. An SDN controller is used both inside a datacenter or over a WAN to control routing of packets for VNF processing, etc. The relationship to the term broadcast network slicing to be discussed later is SDN controllers are used to direct forwarding of packet flows into a defined series of VNF software functions in an SDN/NFV system to create a service. SDN/NFV technology is known and used today to create specific services and is mention here only briefly for context in broadcast virtualization which is novel.

An introduction and definitions of the blocks and how these create the BMX multi-tenant orchestration platform using SDN/NFV is discussed briefly for those skilled in the art. In later discussions references will be made to the blocks in 1200 describing E2E operation or orchestration of the platform.

First at the bottom 1200 is general the compute, storage and networking hardware being abstracted by a hypervisor 1241 controlled by VIM indicated by OpenStack 1244 to create the virtual machines. The BMX frame work is hybrid shown with both VNF 1243 and PNF 1242 manager 1240.

The broadcast service design and creation portal are shown 1201. This provides a well-structured organization of visual design & automation tools, templates and catalogs to model and create resources, and services (set of models use for orchestration). In summary, a comprehensive web-based integrated service design and creation environment with tools, techniques, including automation DevOps pipelines (CI/CD), API and repositories to define/simulate certify system assets as well as their associated processes and policies.

The BMX operational run-time environment 1216. This framework provides real-time, policy driven, context aware orchestration and automation Broadcast/5G Convergence using physical (PNF) and virtual network functions (VNF) with end to end lifecycle management.

The service assurance 1229 is the unified fault management engine actively monitoring the broadcast E2E network health with support for changing landscapes of mixed physical, virtual and cloud environments.

At the top of 1200 is shown external REST-API 1236 and Operation and Maintenance O & M dashboards 1237, 1239 and BSS/OSS 1238.

The BMX operational run-time environment 1216 is discussed briefly. The broadcast network exposure function (BNEF) 1217 and northbound API is very important. Its RESTful APIs allow Application Function (AF) to access broadcast services provided by BMX orchestration for both broadcasters and 5G convergence securely.

The end to end service orchestration engine 1218. Is responsible for allocating, instantiating and activating broadcast network functions (Resources/Spectrum) that are required for an end to end service. It interfaces with Cognitive Spectrum Manager (CSM), Spectrum Resource Manager (SRM), PNFs, VNFs for service provisioning. The NFV BMX Orchestration & Management to request VNFs instantiation and SDN network connectivity through WAN.

The data catalog and analytic engine 1219 consist of several functional components: data collection framework, movement of data/Kafka, Data Lake, and application analytics. Permanently persist the data that flows through BMX OMP and provides ready-to-use data analytics applications built on the data.

Real time active available inventory 1220. This important engine provides real-time or near Realtime view of available Resources and Services and their relationships. Interfaces with Inventory and topology Management engine, SRM, end to end data sources SDN Controllers, Application Controllers, Broadcast Service Orchestrators, Convergence Service Orchestrators, Unified Data Catalog, Event Access engine, BSS/OSS, and 3^{rd} party or Broadcaster.

Microservices bus data mapping (message router) 1221. An Event-driven based communication between services (integration of services) The event bus designed as an interface with the API needed to subscribe and unsubscribe to events and to publish events. Event bus concept allows publisher/subscriber channel communication between services without requiring the components or tenants to explicitly be aware of each other.

SDN-C controller 1222 provides a global broadcast network controller, built on the common controller SDK, which manages, assigns and provisions network resources. A unified logical instance per broadcaster, with multiple geographical diverse VM/Containers in a Broadcast Network clusters to provide efficiency and highly availability.

The Application Controller (APPC) 1224 performs functions to manage the lifecycle of VNFs and their components providing model driven configuration, abstracts cloud/VNF interfaces for repeatable actions, uses vendor agnostic mechanisms (NETCONF, Chef via Chef Server and Ansible) and enables automation.

Multi-VIM cloud adaption layer 1226 provides hyper convergence broadcast network. A common shared data, unified underlying physical and virtualized infrastructure (on-premise Private Cloud, Hybrid cloud, Public cloud) Multi-VIM/Cloud mediation—(Common Open Rest API handler) Unified Provider Registration Information Infrastructure, Resource, SDN overlay, VNF Resource Life Cycle Management, FCAPS fault, configuration, accounting, performance, security. Northbound interface (BNEF) to be consumed by (Multi-broadcasters) SO, SDN-C, APP-C, VF-C, common Data Lake Engines.

Cognitive spectrum manager (VNF) 1227 is centrally located spectrum management entity responsible for all spectrum pools in a national network. It communicates with each SRM located in each regional datacenter. The CSM abstracts all the physical layer complexity from and provides services to BMX orchestration entity which oversees the business of pooled spectrum.

Spectrum resource manager VNF controller 1228 the controller for broadcast resource management function for establishing and maintaining spectrum resource pools for each shared ATSC 3.0 channel.

Blocks inside the service design and creation portal 1201 are now briefly discussed. The resource (spectrum) onboarding 1202 is automation facilitated by applying standards-based approaches to VNF packaging to describe the VNF's infrastructure resource requirements, topology, licensing model, design constraints, and other dependencies to enable successful VNF deployment and management of VNF configuration and operational behavior. The operator of platform will have the capability to onboard tenants quickly through a secured APIs and integrate offerings into the product catalog. The logical separation of broadcast network slices enables independent management of infrastructure, network functions, network services.

The service design 1204 is intricate part of BMX design-time components environment, uses visual tool for designing and modeling assets based on the platform policies and conditional rules important for appropriate orchestration and management. A highly available design function and if there is a platform disruption, the VNF seamlessly continue working as needed and meet the SLAs of that function.

The policy creation and validation 1208 is the BMX policy framework (policy design template). Provides capabilities to create and validate policies/governance rules, identify overlaps, maintains, distributes. Operates based on set of laid down rules that guides control, orchestration and management functions. Policy validator automatically examines newly created policies.

The governance 1209 provides a management framework including flexible business strategies, collaborative and address new and changing technology. Business logic functionalities computations, integration logic, compositions, transformations and anti-corruption layer implementation. The application network function, circuit breaker, time-outs, retries/budgets, service discovery, simple routing, tenant onboarding.

The policy rules 1210 BMX policy framework comprehensive policy design, service deployment, orchestration, control, analytics and execution environment.

The policy framework catalog 1212 operator frameworks tools designed to manage broadcasters, native applications, in a more effective, automated, and scalable. Service level agreements SLA, operator lifecycle manager. Supports machine learning models to build.

The authentication authorization and accounting AAA 1213. Provides security framework for authentication, authorization and accounting (Context Aware).

The home subscriber server HSS 1244 a database that contains subscriber related information, details of authentication, list of services to which each user is entitled or subscribed.

The broadcast market exchange function BMX 1215 a market exchange for spectrum resource commodities.

The analytics and application engine 1205 service engine for analytics on collected data, and for generating intelligence for managing network services and applications.

Online charging system payments 1206 a highly secured convergence charging system/function for composite services—allowing tenants or customers charging, in real time based on service usage. Event based, Session based charging.

The VNF SDK 1207 provides combination interface or reference implementation NETCONF, RESTCONF, vendor specific methodology—CLI, or custom Software development kit to help vendors validate and manage VNF packages.

Finally, BMX orchestration framework and functions described 1200 can be instantiated in a public cloud, private cloud and/or the broadcaster tenant premise as indicated 1235. Moreover, this 1200 is used to instantiate the intelligent system architecture enabling broadcast spectrum pooling and sharing of channels, broadband and 5G convergence 100.

NFV enables great flexibility in new wireless system architectures to create the exact same functions in software using generic commercial off the shelf (COTS) compute, storage, network hardware. This, instead of using a series of monolithic single purpose only hardware appliances (PNF) connected for a single purpose.

The IP packet flows into and out of these software VNFs are chained together by using SDN. An SDN central controller 1222 in datacenter and/or wide area network is used route IP packet flows into VNFs chained together to build real-time wireless broadcast system and services under BMX orchestration 1200. The procedure of constructing a virtual channel service for a tenant by chaining together VNFs (BNEF) 1217 under BMX orchestration is termed a broadcast network slice and is discussed next.

Today and referring to FIG. 4, in SDN/NFV cloud computing system 404, the whole datacenter is abstracted and is treated as a single computer running Linux OS container virtualization 403 under Kubernetes orchestration. Kubernetes is an open source cloud orchestration put into opensource by Google for running containers across clusters of servers. SDN/NFV cloud computing system 404 can be used for the BMX broadcast platform and 3GPP 5G systems in the future 405.

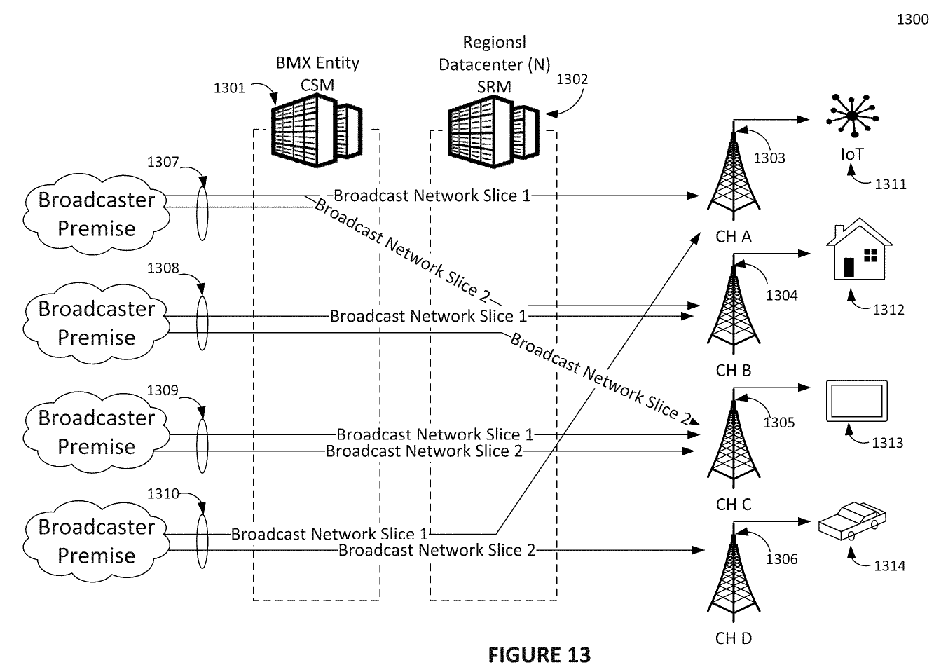

FIG. 13 illustrates concept of broadcast network slicing using the virtualized multi-channel-tenant broadcast sharing platform and SDN/NFV design. In example 1300, each broadcaster has two broadcast network slices. This is the end to end slicing of the complete broadcast network to create a complete service from centralized BMX core 1301 and regional datacenter 1302 to broadcast transmission network 1303, 1304, 1305, 1306. Under BMX orchestration and CSM resource assignment the IP content and/or data flows are accepted into 1301. Each service (slice) IP flows is processed under orchestration and the SLA and policy established with tenant.

Each broadcaster 1307, 1308, 1309, 1310 decides on the use cases and transmission robustness for reception on a frame by frame basis for use cases 1311, 1312, 1313, 1314. The 1301 accepts each tenant's two IP flows and processes the IP flows for network slice 1 and network slice 2 and then sends to the regional datacenter 1302. The SRM of schedulers is used to generate a broadcast waveform for each broadcast slice which is sent to the shared broadcast channel 1303, 1304, 1305, 1306.

Broadcast network slicing is a powerful virtualization capability and one of the key capabilities that will enable flexibility, as it allows multiple logical broadcast network slices to be created on top of a common shared physical infrastructure. The greater elasticity brought about by broadcast network slicing will help to address the cost, efficiency, and flexibility requirements for new broadcaster business models under FCC permitted channel sharing agreements on a voluntary basis for ATSC 3.0. Each broadcaster licensed resources in a spectrum pool are used to instantiate broadcast network slices using the common shared transmission infrastructure of broadcast platform.

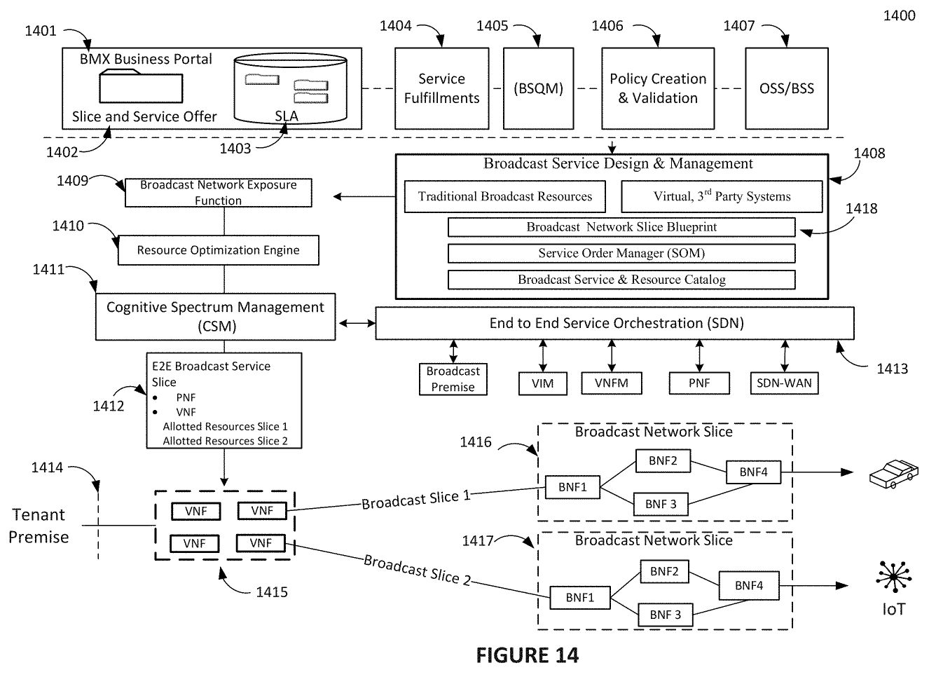

FIG. 14 illustrates more details of broadcast network slicing using the virtualized multi-channel-tenant broadcast sharing platform and SDN/NFV design;

A shown as part of the service design and creation portal 1201 the broadcast service design and creation portal is shown here as the BMX business portal 1401 of platform 1400. The business portal 1401 includes a web application portal for tenant to design, deploy broadcast VNF based on BMX Platform. Provides a secured REST API Broadcast Network Exposure Function. Open and interoperable and support YANG data modeling, Network Configuration Protocol NETCONF, RPC, Transport SSH, HTTP/2, AND Encoding and Decoding XML, JSON.

The slice and service offer 1402 provides efficient broadcast spectrum virtualization and channel sharing connectivity to benefit broadcaster by offering an efficient segment of broadcast core network to support services or business segments.

The platform broadcast network slices are isolated from each other in the control and user planes. Supports use cases of each tenant and the perceived user experience with broadcast network slicing is the same as if each tenant has a private dedicated physical network. Slices are isolated from each other in the control and user planes as well supported use case, the broadcast/user experience of the network slice will be the same as if it was a physically separate network.

The slice and service offer 1402 provides efficient broadcast spectrum virtualization and channel sharing by offering tenant an efficient segment of broadcast core network to support their services or business segments.

The service layer agreement 1403 signed by broadcasters is stored and used to define policy that clearly defines the level of services expected from the platform.

The service fulfillments 1404 the platform modernizes the broadcaster OSS and catalogue-driven fulfilment, with omni-channel approach. A highly automated broadcast service delivery for multi-tenancy environment.

The broadcast service quality management BSQM 1405 incorporates the capability of managing Tenants (Spectrum) service and orchestrating changes based on QoS policies/SLAs. This is critical to the constant negotiation of the broadcast network slice to support the service provisioned to be supported, service monitoring, real-time waveforms, Slice KPIs, spectrum pool monetization, predictive maintenance.

The operation support services OSS and business support services BSS 1407 of each broadcaster business models.

The broadcaster service design and management 1408, provides tools, techniques, and repositories to define/simulate/certify system assets and their associated processes and policies. Assets classified into defined assets groups most important is the broadcast network slice blueprint 1418.

The broadcast network slice blueprint 1418 provides framework for dynamic service orchestration, pre-integrated broadcast workflow automation solution, simplifies operations, zero-touch automated provisioning and insight-driven service assurance. Provide a common orchestrator for broadcast core network, transport and radio access—managing physical, virtual and cloud native network functions. AI-powered closed-loop service assurance automatically adapts the network in real time, maintaining SLAs. Automated onboarding, broadcast network slicing, continuous deployments in a multivendor environment.

The broadcast network exposure function (BNEF) 1409 are all the functions designed by 1408 now located in the run-time environment platform framework as was shown in the BMX operational run-time environment 1216 as discussed above. The resource optimization engines 1410 works with BMX and policy of tenant to assign resources from spectrum pool by CSM 1410. The end to end broadcast network slice service 1412 for both PNF and VNF is illustrated in FIG. 14.

The end to end service orchestration (SDN) controllers 1413 control VNF, PNF, broadcaster premise access (API-GW) and WAN devices in network to enable end to end service under BMX orchestration.

The broadcaster shown under BMX orchestration brings IP content and/or flows across northbound interface 1414 from broadcast premise. The centralized broadcast core functions supporting broadcast slice 1415 is illustrated in FIG. 14.

The broadcast core functions VNF are then chained together and the centralized broadcast core functions supporting broadcast slice 1415 sends broadcast slice 1 to regional datacenter that has SRM controlling scheduler each shared channel 1416. The four broadcast network functions BNF1, BNF2, BNF3, BNF4 are chained together to create the specific waveform for the robustness and QoS requested under SLA. The use case for broadcast network slice 1 is mobile as shown.

The broadcast core functions VNF also are chained together and the centralized broadcast core functions supporting broadcast slice 1415 sends broadcast slice 2 to regional datacenter that has SRM controlling scheduler each shared channel 1417. The four broadcast network functions BNF1, BNF2, BNF3, BNF4 are chained together to create the specific waveform for the robustness and QoS requested under SLA. The use case for broadcast network slice 2 is IoT as shown.

The 5G core network architecture 3GPP 5G release 16 is synergistic to the BMX core. The 5G Core uses concept of Unicast Network Slicing for instantiating all 5G use cases.

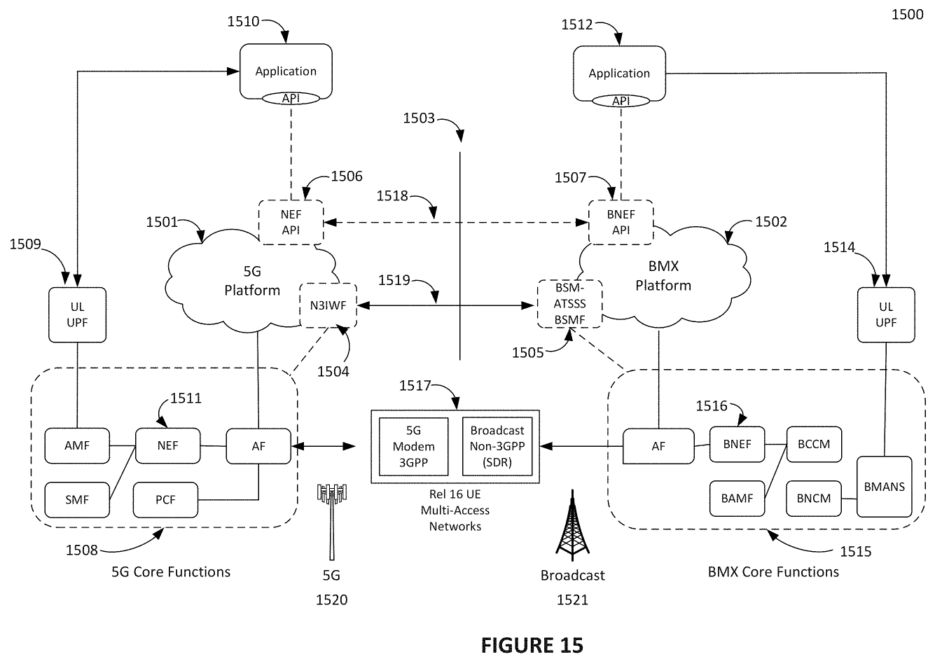

The synergy between the BMX broadcast core functions and 5G core functions is briefly discussed next in FIG. 15. FIG. 15 illustrates view 5G Core release 16 and shared broadcaster core network entities interworking enabling convergence and new industry verticals. This, to disclose high-level interworking of these core network functions is possible using BMX core functions disclosed to enable broadcast 5G convergence to those skilled in art of 5G core architecture functions described in 3GPP TS 23.501 standard release 16.

A platform 1500 shows the BMX broadcast core network functions 1515 and 5G Core network functions 1508 using SDN/NFV architectures as in 402, 403, 404. The main function VNFs used for interworking via the BMX platform westbound interface 1503 is discussed. The paradigm shifts to a new 5G core service-based architecture from 4G and a point-to-point architecture is very enabling. The 5G core service-based architecture (VNF, REST_API) is a synergistic opportunity for layer 3 convergence using the BMX broadcast core and 5G core architecture in release 16

The 3GPP 5G core architecture is standardized in 3GPP TS 23.501 and is not discussed in detail herein. Specifically, the 5G core Network Exposure Function (NEF) 1511 and the (NEF API) 1506 is shown on 5G Platform 1501 for control plane. Also, 5G Non 3GPP Interworking Function (N3IWF) 1504 is shown on 5G platform 1501 for user plane and interworks over interface 1519 with BMX core 1502.

The BMX core Broadcast Network Exposure Function (BNEF) 1516 and (BNEF API) 1507 is shown on BMX platform 1502 for control plane. Also, the (BSM-ATSC-BSMF) 1505 is shown on BMX platform 1502 for user plane and interworks over interface 1519 with 5G Platform 1501.

The BMX core (Broadcast Session Manager), (Access Traffic Steering, Switch and splitting), (Broadcast Session Management Function) BSM-ATSSS-BSMF 1505 interworks over interface 1519 with 1505 5G core and 1504.

The BMX core and 5G core Release 16 both support Access Traffic Splitting, Steering and Switching (ATSSS) with 3GPP and Non-3GPP Multiple Access networks 1517 UE. The 3GPP TS 23.793 can be referenced for discussion of ATSSS in release 16.

The ATSSS interworking is supported by Multi-Access PDU Sessions. The Multi-Access PDU (MA-PDU) session is created by bundling together two separate PDU sessions, established over different access networks 1520 5G, 1521 broadcast using UE 1517 multi-access networks release 16. Now some details of ATSSS is discussed briefly.

In ATSSS, the Steering selects an access network for a new data flow and transfers the traffic of this data flow over the selected access network.

In ATSSS, the Switching moves all traffic of an ongoing data flow from one access network to another access network in a way that maintains the continuity of the data flow.

In ATSSS, the Splitting splits the traffic of a data flow across multiple access networks. When traffic splitting is applied to a data flow, some traffic of the data flow is transferred via one access and some other traffic of the same data flow is transferred via another access.

The BSMF-ATSS BSMF—the ATSSS supports both Trusted and Non-trusted Non-3GPP access networks. The trusted Non-3GPP access mode is for tight trusted integration of broadcast into 5G Core by an MNO only with broadcast spectrum. The Un-trusted Non-3GPP access is used for convergence between broadcaster and 5G MNO and is the model of spectrum consortium in United States and shown 1500.

Further discussion of ATSSS is described in 3GPP TS 23.793 which is synergistic with broadcast as positioned herein as Non-3GPP access network.

The user plane functions 1509, 1514 represents the data user plane function and such things as packet inspections, policy rule enforcement, QoS, etc.

Broadcast Client Connection Manager (BCCM) in 1515 negotiate client's capabilities and needs with BNCM (the best and cost-efficient path) and configures the network path based on usage and needs. The negotiation between BNCM and BCCM enables the best network paths selection dynamically.

The Broadcast Network Connection Manager (BNCM) function in 1515 configures network paths and user plane protocols based on client negotiation with common multi-access network view, network policy and interface to application platforms.

The result is applications 1510, 1510 using the control plane interworking 1518 and user plane interworking 1519 can have a converged user experience on UE 1517 and new use cases in future. Next, a couple of use cases are discussed 1600.

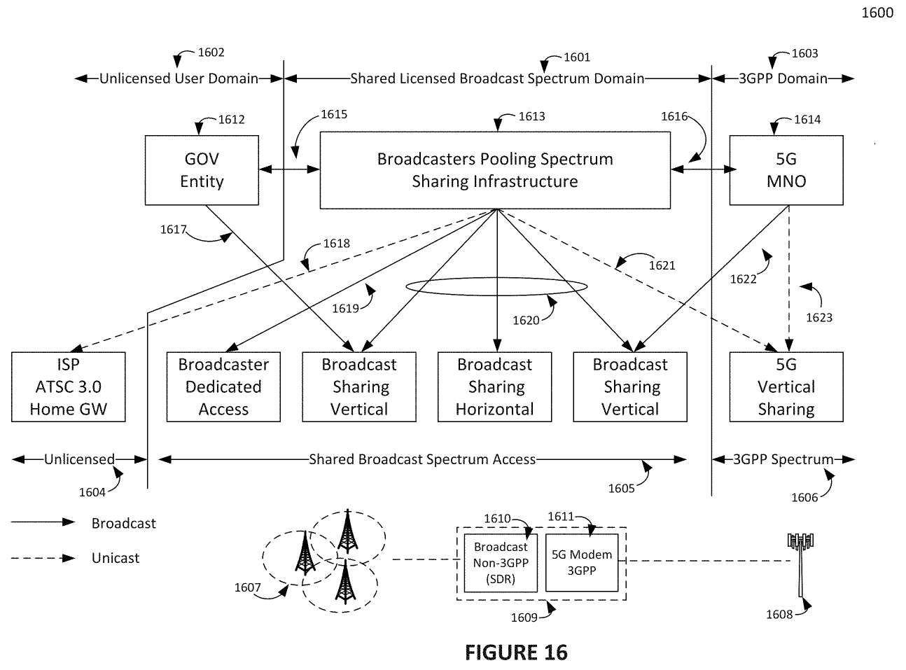

FIG. 16 illustrates use cases of broadcast channel sharing, interworking broadband and 5G convergence using technology and methodology disclosed under orchestration of broadcast market exchange entity. As illustrated in FIG. 16, there is (N) Broadcasters sharing (N) 6 MHz channels under agreements and SLA in the shared licensed broadcast spectrum domain 1601. There is also unlicensed user domain 1602 and 3GPP domain 1603 both can interwork under SLA with 1601.

The licensed broadcast spectrum pools of (N) broadcast channels under SRM, CSM and BMX orchestration is shown 1613. Three of the four 6 MHz licensed broadcast channels 1620 are fully shared in free market using BMX under SLA. One 6 MHz license broadcast channel 1619 is not shared with outside verticals 1612, 1614 and is reserved for licensed broadcasters 1613 dedicated use only.

The 5G MNO 1614 has SLA for convergence with licensed tenants of 1613 and is shown interworking 1616 5G core and broadcast core network. The 5G MNO 1614 is a vertical using shared broadcast spectrum. The BMX orchestration and BNEF 1217 creates a broadcast network slice 1622 to offload 5G traffic using shared licensed broadcast channel under SLA. The 5G offload of content and/or large files in demand by many users can be economic attractive business model for the MNO and not congest the 5G unicast network as previously discussed. The charging for the tenant/s resources used by MNO under SLA is responsibility of BMX.

The 5G MNO unicast services is shown 1623 on 3GPP spectrum 1606. The 1613 tenants also have SLA for 5G unicast services shown 1621. The broadcast core network also provides back office unicast server support for broadcaster software applications on dual connected UE 1609 previously discussed now using 1621 as a vertical on 5G shared network under SLA 1616. The 5G core network is responsible for charging tenant/s 1613 who used 5G unicast resources under layer 3 convergence.

The Government Entity 1612 has been assured access under SLA for public emergency services and/or encrypted private law enforcement use cases. The government entity 1612 is a vertical 1617 using shared broadcast channel under SLA. The SLA and policy for 1612 on BMX for 1612 may guarantee access to broadcast spectrum in emergency use cases and broadcast network slice may be encrypted. The charging for the tenant/s resources used by Government Entity 1612 under SLA is the responsibility of BMX.

The management of the ATSC 3.0 home gateway in homes using intelligence broadcast core and the ISP broadband is shown 1618. The users in home can interact with home gateway using Wi-Fi unlicensed spectrum 1604 as previously discussed. The broadcast spectrum is used 1601 and 3GPP spectrum use 1608 can converge on UE 1609 using 5G Modem 1611 and Broadcast Non-3GPP (SDR) 1610 as previously discussed.

### CONCLUSION

The foregoing Detailed Description referred to accompanying figures to illustrate exemplary embodiments consistent with the disclosure. References in the foregoing Detailed Description to “an exemplary embodiment” indicates that the exemplary embodiment described can include a particular feature, structure, or characteristic, but every exemplary embodiment may not necessarily include the particular feature, structure, or characteristic. Moreover, such phrases are not necessarily referring to the same exemplary embodiment. Further, any feature, structure, or characteristic described in connection with an exemplary embodiment can be included, independently or in any combination, with features, structures, or characteristics of other exemplary embodiments whether or not explicitly described.

The foregoing Detailed Description is not meant to limiting. Rather, the scope of the disclosure is defined only in accordance with the following claims and their equivalents. It is to be appreciated that the foregoing Detailed Description, and not the following Abstract section, is intended to be used to interpret the claims. The Abstract section can set forth one or more, but not all exemplary embodiments, of the disclosure, and thus, is not intended to limit the disclosure and the following claims and their equivalents in any way.

The exemplary embodiments described within foregoing Detailed Description have been provided for illustrative purposes, and are not intended to be limiting. Other exemplary embodiments are possible, and modifications can be made to the exemplary embodiments while remaining within the spirit and scope of the disclosure. The foregoing Detailed Description has been described with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

Embodiments of the disclosure can be implemented in hardware, firmware, software, or any combination thereof. Embodiments of the disclosure can also be implemented as instructions stored on a machine-readable medium, which can be read and executed by one or more processors. A machine-readable medium can include any mechanism for storing or transmitting information in a form readable by a machine (e.g., a computing circuitry). For example, a machine-readable medium can include non-transitory machine-readable mediums such as read only memory (ROM); random access memory (RAM); magnetic disk storage media; optical storage media; flash memory devices; and others. As another example, the machine-readable medium can include transitory machine-readable medium such as electrical, optical, acoustical, or other forms of propagated signals (e.g., carrier waves, infrared signals, digital signals, etc.). Further, firmware, software, routines, instructions can be described herein as performing certain actions. However, it should be appreciated that such descriptions are merely for convenience and that such actions in fact result from computing devices, processors, controllers, or other devices executing the firmware, software, routines, instructions, etc.

The foregoing Detailed Description fully revealed the general nature of the disclosure that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

What is claimed is:

1. A shared broadcast core network, comprising
a plurality of data centers configured to establish a plurality of spectrum resource pools associated with a plurality of broadcast channels serviced by the plurality of data centers;
a cognitive spectrum manager (CSM) entity configured to maintain the plurality of spectrum resource pools as a collective spectrum resource pool; and
a broadcast market exchange (BMX) orchestration entity configured to:
enter into a plurality of service-level agreements (SLAs) between the shared broadcast core network and a plurality of broadcasters relating to usage of the collective spectrum resource pool,
receive a request to deliver content or data from a broadcaster from among the plurality of broadcasters, and
query the CSM for a determination of whether sufficient resource samples from among collective spectrum resource pool are available to satisfy the request to deliver the content or data in accordance with a corresponding SLA from among the plurality of SLAs,
wherein a data center from among the plurality of data center is configured to:
assign the content or data to a plurality of resource samples from among a corresponding spectrum pool from among the plurality of spectrum resource pools in response to the sufficient resource samples being available to satisfy the request, and
schedule the content or data using the plurality of resource samples to provide a plurality of frames to deliver the content over a corresponding broadcast channel from among the plurality of broadcast channels.

2. The shared broadcast core network of claim 1, wherein the collective spectrum resource pool comprises:
a plurality of resource samples representing commodities that are monetized through negotiation with the plurality of broadcasters.

3. The shared broadcast core network of claim 1, wherein the CSM is further configured to:
generate a plurality broadcast frame records indicating utilization of the collective spectrum resource pool, and
provide corresponding broadcast frame records from among the plurality broadcast frame records to the plurality of broadcasters.

4. The shared broadcast core network of claim 1, wherein the plurality of broadcasters represent a spectrum consortium of broadcasters that have entered into channel sharing agreements to voluntarily explore Advanced Television Systems Committee (ATSC) 3.0.

5. The shared broadcast core network of claim 1, wherein the plurality of broadcast channels are 6 MHz broadcast channels as defined an Advanced Television Systems Committee (ATSC) 3.0 standard.

6. The shared broadcast core network of claim 1, wherein the shared broadcast core network is communicatively coupled to a home broadcast gateway, and
wherein the shared broadcast core network is configured to provide second content or data to the home broadcast gateway, and
wherein the second content or data is inserted within the first content or data as the first content or data is being viewed.

7. The shared broadcast core network of claim 6, wherein the second content or data comprises:
an advertisement targeted toward a user of the home broadcast gateway.

8. The shared broadcast core network of claim 1, wherein the shared broadcast core network is communicatively coupled to a cellular core network,
wherein the shared broadcast core network is configured offload the content or data to the data center when transmission of the content or data to the cellular core network would cause congestion in the cellular core network, and
wherein the shared broadcast core network is configured provide the content or data to the cellular core network would not cause the congestion in the cellular core network

9. The shared broadcast core network of claim 7, wherein the cellular core network comprises:
a 5G core network.

10. A datacenter, comprising:
a spectrum resource manager (SRM) configured to:
establish a spectrum resource pool associated with a broadcast channel that is sharable by a plurality of broadcasters, and
assign a first plurality of resource samples from the spectrum resource pool to a first broadcaster from among the plurality of broadcasters and a second plurality of resource samples from the spectrum resource pool to a second broadcaster from among the plurality of plurality of broadcasters; and
a broadcast scheduler configured to schedule first content or data associated with the first broadcaster using the first plurality of resource samples and second content or data associated with the second broadcaster using the second plurality of resource samples to provide a plurality of frames to deliver the first content or data and the second content or data over the broadcast channel.

11. The datacenter of claim 10, wherein the broadcast scheduler is configured to:
determine the first plurality of resource samples required to deliver the first content or data in accordance with a first service-level agreement (SLA) with the first broadcaster, and
determine the second plurality of resource samples required to deliver the second content or data in accordance with the a second SLA with the second broadcaster.

12. The datacenter of claim 10, wherein the broadcast scheduler is configured to determine the first plurality of resource samples and the second first plurality of resource samples in accordance with a sharing algorithm.

13. The datacenter of claim 12, wherein the sharing algorithm is defined by a plurality of equations that describe a number of resource samples in the broadcast channel.

14. The datacenter of claim 13, wherein the number of resource samples in the broadcast channel is a constant number of resource samples per unit of time.

15. The datacenter of claim 10, wherein the broadcast scheduler is configured to:
determine the first plurality of resource samples and the second plurality of resource in accordance with a channel sharing agreement between the first broadcaster and the second broadcaster.

16. The datacenter of claim 10, wherein the broadcast channel is a 6 MHz broadcast channel as defined an Advanced Television Systems Committee (ATSC) 3.0 standard.

17. A multi-tenant-channel virtualized broadcast platform, comprising:
a core cellular network; and
a shared broadcast core network configured to:
receive a request to deliver content or data from a broadcaster from among a plurality of broadcasters,
offload the content or data to the cellular network for delivery to a first modem of a dual connected user device when transmission of the content or data to the cellular core network would not cause congestion in the cellular network,
assign the content or data to a plurality of resource samples from among a corresponding spectrum pool from among the plurality of spectrum resource pools in response to the content or data causing congestion in the cellular network, and
schedule the content or data using the plurality of resource samples to provide a plurality of frames to deliver the content over a corresponding broadcast channel from among the plurality of broadcast channels for delivery to a second modem of the dual connected user device.

18. The multi-tenant-channel virtualized broadcast platform of claim 17, wherein the core cellular network comprises:
a 5G core network.

19. The multi-tenant-channel virtualized broadcast platform of claim 17, wherein the first modem comprises:
a 5G modem, and
wherein the second modem comprises:
a non-3GPP modem.

20. The datacenter of claim 16, wherein the plurality of broadcast channels are 6 MHz broadcast channels as defined an Advanced Television Systems Committee (ATSC) 3.0 standard.
